(19) United States
(12) Patent Application Publication
(10) Pub. No.: US 2024/0375666 A1
(43) Pub. Date: Nov. 14, 2024

(54) METHOD FOR DESIGNING DRIVING SYSTEM, STORAGE MEDIUM, AND DRIVING SYSTEM

(71) Applicant: DENSO CORPORATION, Kariya-city (JP)

(72) Inventors: ATSUSHI BABA, Kariya-city (JP); TETSUYA TOHDO, Kariya-city (JP); HIROSHI KUWAJIMA, Kariya-city (JP)

(21) Appl. No.: 18/781,826

(22) Filed: Jul. 23, 2024

Related U.S. Application Data
(63) Continuation of application No. PCT/JP2023/000826, filed on Jan. 13, 2023.

(30) Foreign Application Priority Data
Jan. 25, 2022 (JP) 2022-009646

(51) Int. Cl. B60W 50/00; B60W 50/02

(52) U.S. Cl. CPC B60W 50/0098; B60W 50/0205; B60W 2050/0008

(57) ABSTRACT

A design method of a driving system, which includes a plurality of subsystems and implements a dynamic driving task of a subject vehicle in cooperation with each of the subsystems, includes: calculating an error occurring in each of temporarily designed subsystems; tentatively allocating, to each of the subsystems, an allowable deviation that is allowed for an entire driving system; specifying an allowable error, which is allowed for each of the subsystems, from a deviation allocated to each of the subsystems based on an evaluation on an error propagating through the driving system; and adjusting allocation of the allowable error to each of the subsystems based on a result of comparing the calculated error with an allowable error of the subsystem corresponding to the calculated error.

### CROSS REFERENCE TO RELATED APPLICATIONS

This application is a continuation application of International Patent Application No. PCT/JP2023/000826 filed on Jan. 13, 2023, which designated the U.S. and claims the benefit of priority from Japanese Patent Application No. 2022-009646 filed on Jan. 25, 2022. The entire disclosure of all of the above application is incorporated herein by reference.

### TECHNICAL FIELD

The present disclosure relates to a technology of implementing a driving system of a moving object.

### BACKGROUND ART

In an evaluation method of a driving system, a driving support function is evaluated based on behavior of a self-travel object in response to the behavior of an object controlled by a person in a game environment.

### SUMMARY

In one aspect of the present disclosure, a design method of a driving system, which includes a plurality of subsystems and implements a dynamic driving task of a moving object in cooperation with each of the subsystems, including:
calculating an error occurring in each of temporarily designed subsystems;
tentatively allocating, to each of the subsystems, an allowable deviation that is allowed for an entire driving system;
specifying an allowable error, which is allowed for each of the subsystems, from a deviation allocated to each of the subsystems based on an evaluation on an error propagating through the driving system; and
adjusting allocation of the allowable error to each of the subsystems based on a result of comparing the calculated error with an allowable error of the subsystem corresponding to the calculated error.

### BRIEF DESCRIPTION OF DRAWINGS

FIG. 1 is a block diagram showing a schematic configuration of a driving system.

FIG. 2 is a block diagram showing a configuration of a technical level of the driving system.

FIG. 3 is a block diagram showing a configuration of a functional level of the driving system.

FIG. 4 is a diagram showing a control state space of a vehicle.

FIG. 5 is a block diagram showing a causal loop of the driving system.

FIG. 6 is a diagram illustrating an inner loop.

FIG. 7 is a diagram illustrating an outer loop.

FIG. 8 is a diagram showing regions where safety cannot be maintained based on the concept of a first evaluation method.

FIG. 9 is a flowchart illustrating the first evaluation method.

FIG. 10 is a diagram showing a region where safety cannot be maintained based on a concept of a second evaluation method.

FIG. 11 is a flowchart illustrating the second evaluation method.

FIG. 12 is a diagram showing a region where safety cannot be maintained based on a concept of a third evaluation method.

FIG. 13 is a flowchart illustrating a third evaluation method.

FIG. 14 is a flowchart illustrating an evaluation method based on reliability.

FIG. 15 is a block diagram showing an evaluation device and a design device.

FIG. 16 is a graph showing a relationship between error distribution and reliability.

FIG. 17 is a flowchart illustrating a first design method.

FIG. 18 is a block diagram showing a causal loop of the driving system.

FIG. 19 is a diagram illustrating an inner loop.

FIG. 20 is a diagram illustrating an outer loop.

FIG. 21 is a diagram illustrating a vehicle body stabilization loop.

FIG. 22 is a table showing various errors.

FIG. 23 is a flowchart illustrating an evaluation method based on an error.

FIG. 24 is a flowchart illustrating a second design method.

FIG. 25 is a flowchart illustrating processing of the driving system.

FIG. 26 is a block diagram showing a configuration of a functional level of the driving system.

FIG. 27 is a block diagram showing a configuration of a technical level of the driving system.

FIG. 28 is a flowchart illustrating processing of the driving system.

FIG. 29 is a block diagram showing a configuration of a functional level of the driving system.

FIG. 30 is a block diagram showing a configuration of a technical level of the driving system.

### DESCRIPTION OF EMBODIMENTS

Next, a relevant technology will be described only for understanding the following embodiments.

The driving system as described above is complicated such that multiple subsystems are included. For this reason, simple tests that evaluate a response to the behavior have limitations in appropriately confirming the validity of the driving system including each subsystem. Therefore, it is difficult to implement a driving system with high validity by optimizing the design of the driving system.

An objective of the present disclosure is to provide a design method for enhancing validity of a driving system or a driving system with high validity.

In a first aspect of the present disclosure, a design method of a driving system, which includes a plurality of subsystems and implements a dynamic driving task of a moving object in cooperation with each of the subsystems, including:
calculating an error occurring in each of temporarily designed subsystems;
tentatively allocating, to each of the subsystems, an allowable deviation that is allowed for an entire driving system;
specifying an allowable error, which is allowed for each of the subsystems, from a deviation allocated to each of the subsystems based on an evaluation on an error propagating through the driving system; and
adjusting allocation of the allowable error to each of the subsystems based on a result of comparing the calculated error with an allowable error of the subsystem corresponding to the calculated error.

According to such an aspect, allocation of an allowable error to each of subsystems is adjusted. In such adjustment, comparison between an error occurring in each of temporarily designed subsystems and the allowable error is used. The allowable error is specified by evaluating a tentatively allocated deviation of the allowable error of an entire driving system to each of the subsystems and an error propagating through the driving system. As a result of the evaluation of the error propagating through the driving system, a composite factor based on an interaction between each of the subsystems can be reflected in the design. Therefore, the validity of the driving system including multiple subsystems can be enhanced.

In a second aspect of the present disclosure, a design method of a driving system, which includes a plurality of subsystems and implements a dynamic driving task of a moving object in cooperation with each of the subsystems, including:
introducing reliability into each of the subsystems as a common measure between each of the subsystems to evaluate a composite factor between the subsystems;
allocating the reliability to each of subsystems based on a specification of the driving system; and
determining the specification of each of the subsystems such that an error, which is generated in each of the subsystems and propagates through the driving system, falls within an allowable error with a probability of a predetermined reliability or higher.

According to such an aspect, a specification of each of subsystems is determined such that an error propagating through a driving system will fall within an allowable error with a probability greater than or equal to a predetermined reliability. That is, the reliability is introduced as a common measure by applying evaluation based on probability theory to each of the subsystems. Therefore, even when a perception system, a determination system, and a control system each have different functions, a composite factor caused by an interaction therebetween can be appropriately reflected in the design. Therefore, the validity of the driving system including multiple subsystems can be enhanced.

In a third aspect of the present disclosure, a driving system which includes a plurality of subsystems and implements a dynamic driving task of a moving object in cooperation with each of the subsystems, including:
at least one storage medium that is configured to store an allocation of reliability to each of the subsystems, the allocation of the reliability being a common measure between each of the subsystems and being defined for each allocation category; and
at least one processor configured to change a condition for implementing the dynamic driving task based on the allocation of the reliability.

According to such an aspect, conditions for implementing a dynamic driving task are changed based on allocation of reliability to each of subsystems stored in a storage medium. That is, since the reliability, which is a common measure between each of the subsystems, is used, even when a perception system, a determination system, and a control system each have different functions, it is possible to change the conditions in consideration of a load applied to each of the subsystems, which may vary depending on an allocation category. Therefore, the high validity can be implemented in the driving system including multiple subsystems.

In a fourth aspect of the present disclosure, a non-transitory, computer readable storage medium stores a program for a driving system, which includes a plurality of subsystems and implements a dynamic driving task of a moving object in cooperation with each of the subsystems. The program, when executed by at least one processor, causes the at least one processor to:
calculate an error occurring in each of temporarily designed subsystems;
tentatively allocate, to each of the subsystems, an allowable deviation that is allowed for an entire driving system;
specify an allowable error, which is allowed for each of the subsystems, from a deviation allocated to each of the subsystems based on an evaluation on an error propagating through the driving system; and
adjust allocation of the allowable error to each of the subsystems based on a result of comparing the calculated error with an allowable error of the subsystem corresponding to the calculated error.

In a fifth aspect of the present disclosure, a non-transitory, computer readable storage medium stores a program for a driving system, which includes a plurality of subsystems and implements a dynamic driving task of a moving object in cooperation with each of the subsystems. The program, when executed by at least one processor, causes the at least one processor to:
introduce reliability into each of the subsystems as a common measure between each of the subsystems to evaluate a composite factor between the subsystems;
allocate the reliability to each of subsystems based on a specification of the driving system; and
determine the specification of each of the subsystems such that an error, which is generated in each of the subsystems and propagates through the driving system, falls within an allowable error with a probability of a predetermined reliability or higher.

Hereinafter, multiple embodiments will be described with reference to the drawings. It should be noted that the same reference numerals are allocated to the corresponding components in the respective embodiments, so that overlapping descriptions may be omitted. When only a part of the configuration is described in each embodiment, the configurations of the other embodiments described above can be applied to the other parts of the configuration. Further, in addition to combinations of configurations explicitly shown in the description of the embodiments, the configurations of multiple embodiments can be partially combined even when the combinations are not explicitly shown as long as there is no problem in the combinations in particular.

### First Embodiment

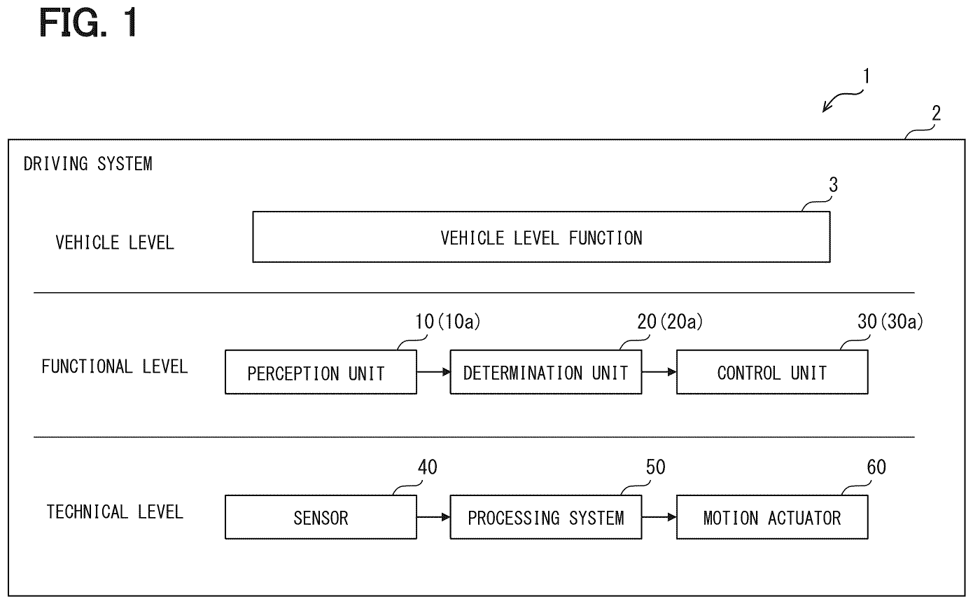

A driving system 2 of a first embodiment shown in FIG. 1 implements a function related to driving of a moving object. A part or all of the driving system 2 is mounted on the moving object. The moving object serving as a processing target by the driving system 2 is a vehicle. This vehicle can be referred to as a subject vehicle 1 and corresponds to a host moving object. The subject vehicle 1 may be configured to communicate with the other vehicle directly or indirectly via a communication infrastructure. The other vehicle corresponds to a target moving object.

The subject vehicle 1 is, for example, a road user capable of autonomously driving a car, a truck, or the like. Driving is classified into levels according to a range or the like of all dynamic driving tasks (DDT) that are performed by a driver. The autonomous driving level is defined by, for example, SAE J3016. At Levels 0 to 2, the driver performs some or all of the DDT. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs all of the DDT while being engaged. Levels 3 to 5 may be classified as so-called autonomous driving. The driving system 2 that can perform driving at Level 3 or higher may be referred to as an automated driving system. Level 3 indicates that driving is conditionally automated. Level 4 indicates that driving is highly automated. Level 5 indicates that driving is fully automated.

Furthermore, the driving system 2 that cannot perform driving at Level 3 or higher but can perform driving at at least one of Levels 1 and 2 may be referred to as a driving support system. In the following, unless there is a particular reason to specify the maximum achievable level of autonomous driving, the description will be continued by simply referring to the automated driving system or the driving support system as the driving system 2.

### <Sense-Plan-Act Model>

An architecture of the driving system 2 is selected such that an efficient safety of the intended functionality (SOTIF) process can be implemented. For example, the architecture of the driving system 2 may be configured based on a sense-plan-act model. The sense-plan-act model includes a sense element, a plan element, and an act element as main system elements. The sense element, the plan element, and the act element interact with each other. Sense can be read as perception, plan as judgement, and act as control, and in the following, the description will be continued mainly using the words perception, judgement, and control.

As shown in FIG. 1, at the vehicle level in such a driving system 2, a vehicle level function 3 is implemented based on a vehicle level safety strategy (VLSS). At a functional level (in other words, a functional view), a perception function, a determination function, and a control function are implemented. At a technical level (in other words, a technical view), multiple sensors 40 corresponding to the perception function, a processing system 50 corresponding to the determination function, and multiple motion actuators 60 corresponding to the control function are implemented.

Specifically, a perception unit 10, which is a functional block that implements the perception function, may be constructed in the driving system 2, mainly including multiple sensors 40, a processing system that processes detection information of the multiple sensors 40, and a processing system that generates an environment model based on information of multiple sensors 40. The determination unit 20, which is a functional block that implements the determination function, may be constructed in the driving system 2, mainly including the processing system as a main component. The control unit 30, which is a functional block that implements the control function, may be constructed in the driving system 2, mainly including multiple motion actuators 60 and at least one processing system that outputs operation signals for multiple motion actuators 60.

In this case, the perception unit 10 may be implemented in the form of a perception system 10a as a subsystem that is provided to be distinguishable from the determination unit 20 and the control unit 30. The determination unit 20 may be implemented in the form of a determination system 20a as a subsystem that is provided to be distinguishable from the perception unit 10 and the control unit 30. The control unit 30 may be implemented in the form of a control system 30a as a subsystem that is provided to be distinguishable from the perception unit 10 and the determination unit 20. The perception system 10a, the determination system 20a, and the control system 30a may constitute mutually independent components.

Furthermore, the subject vehicle 1 may be mounted with multiple human machine interface (HMI) devices 70. A portion of multiple HMI devices 70 that implements an operation input function by an occupant may be a part of the perception unit 10. A portion of multiple HMI devices 70 that implements an information presentation function may be part of the control unit 30. On the other hand, a function implemented by the HMI device 70 may be positioned as a function independent of the perception function, the determination function, and the control function.

The perception unit 10 manages the perception function including localization of road users such as the subject vehicle 1 and the other vehicle. The perception unit 10 detects the external environment EE, an internal environment, and a vehicle state of the subject vehicle 1, and a state of the driving system 2. The perception unit 10 fuses the detected information to generate an environment model. The determination unit 20 applies the purpose and driving policy to the environment model generated by the perception unit 10 to derive a control action. The control unit 30 executes the control action derived by a perception element.

### <System Configuration of Technical Level>

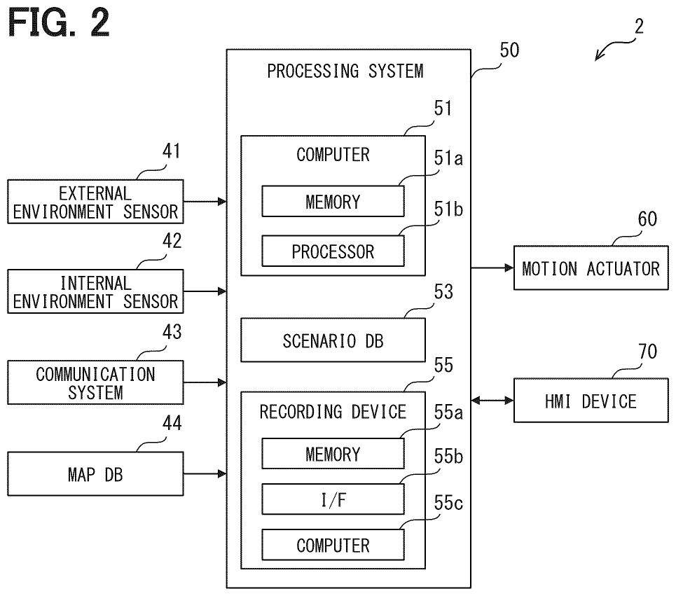

An example of a detailed configuration of the driving system 2 at a technical level will be described with reference to FIG. 2. The technical level configuration may mean a physical architecture. The driving system 2 includes multiple sensors 40, multiple motion actuators 60, multiple HMI devices 70, at least one processing system 50, and the like. These components can communicate with each other through wireless and/or wired connections. These components may be able to communicate with each other through an in-vehicle network such as CAN (registered trademark).

Multiple sensors 40 include one or more external environment sensors 41. Multiple sensors 40 may include at least one type of one or more internal environment sensors 42, one or more communication systems 43, and a map database (DB) 44. When the sensor 40 is narrowly interpreted as indicating the external environment sensor 41, the internal environment sensor 42, the communication system 43, and the map DB 44 may be positioned as separate components from the sensor 40 whose perception function corresponds to the technical level.

The external environment sensor 41 may detect a target present in the external environment EE of the subject vehicle 1. The target detection type external environment sensor 41 is, for example, a camera, a light detection and ranging/laser imaging detection and ranging (LIDAR), laser radar, a millimeter wave radar, an ultrasonic sonar, or the like. Typically, a combination of multiple types of external environment sensors 41 may be implemented to monitor the front, side, and rear directions of the subject vehicle 1.

As an example of mounting the external environment sensor 41, the subject vehicle 1 may be mounted with multiple cameras (for example, 11 cameras) configured to respectively monitor the front, front side, side, rear side, and rear directions of the subject vehicle 1.

As another mounting example, the subject vehicle 1 may be mounted with multiple cameras (for example, four cameras) each configured to monitor the front, side, rear of the subject vehicle 1, and multiple millimeter wave radars (for example, five millimeter wave radars) each configured to monitor the front, front side, side, and rear of the subject vehicle 1, and a LIDAR configured to monitor the front of the subject vehicle 1.

Furthermore, the external environment sensor 41 may detect an atmospheric state and a weather state in the external environment EE of the subject vehicle 1. The state detection type external environment sensor 41 is, for example, an outside air temperature sensor, a temperature sensor, a raindrop sensor, or the like.

The internal environment sensor 42 may detect a specific physical quantity related to vehicle motion (hereinafter referred to as a motion physical quantity) in the internal environment of the subject vehicle 1. The motion physical quantity detection type internal environment sensor 42 is, for example, a speed sensor, an acceleration sensor, a gyro sensor, or the like. The internal environment sensor 42 may detect a state of the occupant in the internal environment of the subject vehicle 1. The occupant detection type internal environment sensor 42 is, for example, an actuator sensor, a driver monitoring sensor and a system thereof, a biological sensor, a seating sensor, an in-vehicle device sensor, or the like. In particular, examples of the actuator sensor include an accelerator sensor, a brake sensor, and a steering sensor that detect an operation state of the occupant with respect to the motion actuator 60 related to motion control of the subject vehicle 1.

The communication system 43 acquires communication data that can be used in the driving system 2 through wireless communication. The communication system 43 may receive a positioning signal from a global navigation satellite system (GNSS) satellite existing in the external environment EE of the subject vehicle 1. The positioning type communication device in the communication system 43 is, for example, a GNSS receiver or the like.

The communication system 43 may transmit and receive a communication signal to and from a V2X system existing in the external environment EE of the subject vehicle 1. The V2X type communication device in the communication system 43 is, for example, a dedicated short range communications (DSRC) communication device, a cellular V2X (C-V2X) communication device, or the like. Examples of the communication with the V2X system existing in the external environment EE of the subject vehicle 1 include communication with a communication system of the other vehicle (V2V), communication with infrastructure such as a communication device set in a traffic light (V2I), communication with a mobile terminal of a pedestrian (V2P), communication with a network such as a cloud server (V2N), and the like.

Furthermore, the communication system 43 may transmit and receive a communication signal to and from the internal environment of the subject vehicle 1, for example, with a mobile terminal such as a smartphone existing in the vehicle. The terminal communication type communication device in the communication system 43 is, for example, a Bluetooth (registered trademark) device, a Wi-Fi (registered trademark) device, an infrared communication device, or the like.

The map DB 44 is a database that stores map data that can be used in the driving system 2. The map DB 44 includes, for example, at least one type of non-transitory tangible storage medium of a semiconductor memory, a magnetic medium, an optical medium, or the like. The map DB 44 may include a database of a navigation unit that navigates a travel path of the subject vehicle 1 to the destination. The map DB 44 may include a database of a PD map generated using probe data (PD) collected from each vehicle. The map DB 44 may include a database of a high accuracy map with a high level of accuracy used mainly for an automated driving system. The map DB 44 may include a parking lot map database including detailed parking lot information used for automatic parking or parking assistance, such as parking frame information.

The map DB 44 suitable for the driving system 2 acquires and stores the latest map data through communication with a map server via the V2X type communication system 43, for example. The map data is data representing the external environment EE of the subject vehicle 1 and is converted into two-dimensional or three-dimensional data. The map data may include, for example, road data representing at least one type among the position coordinates, shape, road surface condition, and standard traveling road of a road structure. The map data may include, for example, marking data representing at least one type among position coordinates, shapes, and the like among traffic signs, road markings, and lane markings attached to roads. The marking data included in the map data may represent targets such as traffic signs, arrow markings, lane markings, stop lines, direction signs, landmark beacons, business signs, changes in road line patterns, and the like. The map data may include, for example, structure data representing at least one type of position coordinates, a shape, and the like of a building and a traffic light facing the road. The marking data included in the map data may represent, for example, street lamps, road edges, reflecting plates, poles, and the like, among the targets.

The motion actuator 60 can control a vehicle motion based on an input control signal. The drive type motion actuator 60 is, for example, a power train including at least one of an internal combustion engine, a drive motor, and the like. The braking type motion actuator 60 is, for example, a brake actuator. The steering type motion actuator 60 is, for example, a steering wheel.

The HMI device 70 may be an operation input device capable of inputting an operation by the driver in order to transmit, to the driving system 2, the will or intention of the occupant of the subject vehicle 1 including the driver. The operation input type HMI device 70 is, for example, an accelerator pedal, a brake pedal, a shift lever, a steering wheel, a turn signal lever, a mechanical switch, a touch panel of a navigation unit, or the like. Among these, the accelerator pedal controls the power train as the motion actuator 60. The brake pedal controls a brake actuator as the motion actuator 60. The steering wheel controls a steering actuator as the motion actuator 60.

The HMI device 70 may be an information presentation device that presents information such as visual information, auditory information, skin sensation information, and the like to the occupant of the subject vehicle 1 including the driver. The visual information presentation type HMI device 70 is, for example, a combination meter, a navigation unit, a center information display (CID), a head-up display (HUD), an illumination unit, or the like. The auditory information presentation type HMI device 70 is, for example, a speaker, a buzzer, or the like. The skin sensation information presentation type HMI device 70 is, for example, a steering wheel vibration unit, a driver's seat vibration unit, a steering wheel reaction force unit, an accelerator pedal reaction force unit, a brake pedal reaction force unit, an air conditioning unit, or the like.

The HMI device 70 may implement an HMI function in cooperation with a mobile terminal such as a smartphone by mutually communicating with the terminal through the communication system 43. For example, the HMI device 70 may present information acquired from a smartphone to an occupant including the driver. In addition, for example, an operation input of the smartphone may be used as an alternative to an operation input to the HMI device 70.

At least one processing system 50 is provided. For example, the processing system 50 may be an integrated processing system that integrally executes processing related to the perception function, processing related to the determination function, and processing related to the control function. In this case, the integrated processing system 50 may further execute processing related to the HMI device 70, or an HMI-dedicated processing system may be provided separately. For example, the HMI-dedicated processing system may be an integrated cockpit system that integrally executes processing related to each HMI device.

For example, the processing system 50 may include at least one processing unit corresponding to processing related to the perception function, at least one processing unit corresponding to processing related to the determination function, and at least one processing unit corresponding to processing related to the control function.

The processing system 50 includes a communication interface for the outside, and is connected to at least one type of elements related to the processing performed by the processing system 50 among the sensor 40, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may implement functions such as the perception function, the determination function, and the control function by combining multiple dedicated computers 51.

For example, the dedicated computer 51 constituting the processing system 50 may be an integrated ECU that integrates a driving function of the subject vehicle 1. The dedicated computer 51 constituting the processing system 50 may be a determination ECU that determines DDT. The dedicated computer 51 constituting the processing system 50 may be a monitoring ECU that monitors the driving of the vehicle. The dedicated computer 51 constituting the processing system 50 may be an evaluation ECU that evaluates the driving of the vehicle. The dedicated computer 51 constituting the processing system 50 may be a navigation ECU that navigates the travel path of the subject vehicle 1.

The dedicated computer 51 constituting the processing system 50 may be a locator ECU that estimates a position of the subject vehicle 1. The dedicated computer 51 constituting the processing system 50 may be an image processing ECU that processes image data detected by the external environment sensor 41. The dedicated computer 51 constituting the processing system 50 may be an actuator ECU that controls the motion actuator 60 of the subject vehicle 1. The dedicated computer 51 constituting the processing system 50 may be an HMI control unit (HCU) that integrally controls the HMI device 70. The dedicated computer 51 constituting the processing system 50 may be at least one external computer that constructs an external center or a mobile terminal that enables communication via the communication system 43, for example.

The dedicated computer 51 constituting the processing system 50 has at least one memory 51a and at least one processor 51b. The memory 51a may be at least one type of non-transitory tangible storage medium, such as a semiconductor memory, a magnetic medium, an optical medium, and the like, which non-temporarily stores a program, data, and the like that can be read by the processor 51b. Furthermore, a rewritable volatile storage medium such as a random access memory (RAM) may be provided as the memory 51a. The processor 51b includes, as a core, at least one type of, for example, a central processing unit (CPU), a graphics processing unit (GPU), and a reduced instruction set computer (RISC)-CPU.

The dedicated computer 51 constituting the processing system 50 may be a system on a chip (SoC) that is implemented by integrating the memory, the processor, and the interface as one chip, and may have an SoC as a component of the dedicated computer.

Furthermore, the processing system 50 may include at least one database for executing a dynamic driving task. The database includes at least one type of non-transitory tangible storage medium, such as a semiconductor memory, a magnetic medium, and an optical medium. The database may be a scenario DB 53 that is a database of a scenario structure described later.

The processing system 50 may include at least one recording device 55 that records at least one of perception information, determination information, and control information of the driving system 2. The recording device 55 may include at least one memory 55a and an interface 55b for writing data to the memory 55a. The memory 55a may be at least one type of non-transitory tangible storage medium among, for example, a semiconductor memory, a magnetic medium, and an optical medium.

At least one of the memories 55a may be mounted on a substrate in the form that is not easily detachable or replaceable, and in this form, for example, an embedded multi media card (eMMC) using a flash memory may be adopted. At least one of the memories 55a may be in the form that is detachable and replaceable with respect to the recording device 55, and in this form, for example, an SD card or the like may be adopted.

The recording device 55 may have a function of selecting information to be recorded from perception information, determination information, and control information. In this case, the recording device 55 may include a dedicated computer 55c. The processor provided in the recording device 55 may temporarily store information in a RAM or the like. The processor may select information to be recorded from among the temporarily stored information and store the selected information in the memory 51a.

The recording device 55 may access the memory 55a and perform recording in accordance with a data write command from the perception system 10a, the determination system 20a, or the control system 30a. The recording device 55 may determine information flowing through the in-vehicle network, access the memory 55a, and execute recording based on determination of a processor provided in the recording device 55.

### <System Configuration of Functional Level>

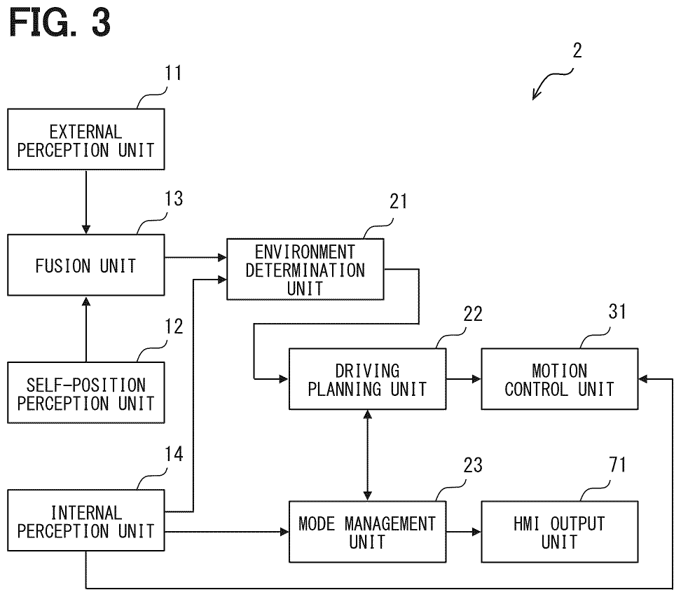

Next, an example of the detailed configuration of the driving system 2 at the functional level will be described with reference to FIG. 3. The configuration of the functional level may mean a logical architecture. The perception unit 10 includes an external perception unit 11, a self-position perception unit 12, a fusion unit 13, and an internal perception unit 14 as sub-blocks into which the perception function is further divided.

The external perception unit 11 individually processes detection data detected by each external environment sensor 41, and implements a function of recognizing objects such as targets and other road users. The detection data may be, for example, detection data provided by millimeter wave radar, sonar, LiDAR, or the like. The external perception unit 11 may generate relative position data including the direction, size, and distance of the object with respect to the subject vehicle 1 from the unprocessed data detected by the external environment sensor.

The detection data may be image data provided from a camera or LiDAR, for example. The external perception unit 11 processes the image data and extracts objects reflected within an angle of view of the image. The extraction of the object may include estimation of the direction, size, and distance of the object with respect to the subject vehicle 1. In addition, the extraction of the object may include object class classification using, for example, semantic segmentation.

The self-position perception unit 12 performs localization of the subject vehicle 1. The self-position perception unit 12 acquires global position data of the subject vehicle 1 from the communication system 43 (for example, the GNSS receiver). In addition, the self-position perception unit 12 may acquire at least one of position information of a target extracted by the external perception unit 11 and position information of the target extracted by the fusion unit 13. Further, the self-position perception unit 12 acquires map information from the map DB 44. The self-position perception unit 12 integrates these types of information and estimates a position of the subject vehicle 1 on the map.

The fusion unit 13 fuses the external perception information of each external environment sensor 41 processed by the external perception unit 11, localization information processed by the self-position perception unit 12, and V2X information acquired by V2X.

The fusion unit 13 fuses object information of other road users and the like individually recognized by each external environment sensor 41, and specifies types and relative positions of objects around the subject vehicle 1. The fusion unit 13 fuses road target information individually recognized by each external environment sensor 41 to specify a static structure of a road around the subject vehicle 1. The static structure of a road includes, for example, curve curvature, number of lanes, free space, and the like.

Next, the fusion unit 13 fuses the type and relative position of the object around the subject vehicle 1, the static structure of a road around the subject vehicle 1, the localization information, and the V2X information, to generate an environment model. The environment model can be provided to the determination unit 20. The environment model may be an environment model specialized for modeling the external environment EE.

The environment model may be an integrated environment model obtained by fusing information such as an internal environment, a vehicle state, and a state of the driving system 2, which is implemented by extending the acquired information. For example, the fusion unit 13 may acquire traffic rules such as the Road Traffic Act and reflect the same on the environment model.

The internal perception unit 14 processes the detection data detected by each internal environment sensor 42 and implements a function of recognizing the vehicle state. The vehicle state may include a state of motion physical quantities of the subject vehicle 1 detected by a speed sensor, an acceleration sensor, a gyro sensor, or the like. In addition, the vehicle state may include at least one of states of the occupant including the driver, an operation state of the driver for the motion actuator 60, and a switch state of the HMI device 70.

The determination unit 20 includes an environment determination unit 21, a driving planning unit 22, and a mode management unit 23 as sub-blocks into which the determination function is further classified.

The environment determination unit 21 acquires the environment model generated by the fusion unit 13 and a vehicle state recognized by the internal perception unit 14, executes determination on an environment based on the environment model and the vehicle state. Specifically, the environment determination unit 21 may interpret the environment model and estimate a situation in which the subject vehicle 1 is currently placed. The situation herein may be an operational situation. The environment determination unit 21 may interpret the environment model and predict the trajectory of objects such as other road users. In addition, the environment determination unit 21 may also interpret the environment model to predict potential hazards.

The environment determination unit 21 may interpret the environment model and make a determination on a scenario in which the subject vehicle 1 is currently placed. The determination on the scenario may be made by selecting at least one scenario in which the subject vehicle 1 is currently placed from a catalog of the scenario constructed in the scenario DB 53. The determination on the scenario may be a determination on a scenario category, which will be described later.

Furthermore, the environment determination unit 21 may estimate a driver's intention based on at least one of the predicted trajectory of the object, the predicted potential hazard, and the determination on the scenario, and the vehicle state provided from the internal perception unit 14.

The driving planning unit 22 plans the driving of the subject vehicle 1 based on at least one of estimation information of the position of the subject vehicle 1 on the map obtained by the self-position perception unit 12, determination information and driver intention estimation information obtained by the environment determination unit 21, function restriction information obtained by the mode management unit 23, and the like.

The driving planning unit 22 implements a route planning function, a behavior planning function, and a trajectory planning function. The route planning function is a function of planning at least one of a route to a destination and a medium-distance lane plan based on estimation information of the position of the subject vehicle 1 on the map. The route planning function may further include a function of determining at least one of a lane change request and a deceleration request based on the medium-distance lane plan. The route planning function may be a mission/route planning function in a strategic function, and may output a mission plan and a route plan.

The behavior planning function is a function of planning a behavior of the subject vehicle 1 based on at least one of a route to the destination, a medium-distance lane plan, a lane change request and a deceleration request planned by the route planning function, determination information and the driver intention estimation information obtained by the environment determination unit 21, and the function restriction information obtained by the mode management unit 23. The behavior planning function may include a function of generating conditions regarding state transition of the subject vehicle 1. The condition regarding a state transition of the subject vehicle 1 may correspond to a triggering condition. The behavior planning function may include a function of determining the state transition of an application that implements DDT, and further the state transition of driving action, based on the condition. The behavior planning function may include a function of determining constraints on a path of the subject vehicle 1 in a longitudinal direction and constraints on a path of the subject vehicle 1 in a lateral direction based on information of these state transitions. The behavior planning function may be a strategic behavior plan in a DDT function, and may output the strategic behavior.

The trajectory planning function is a function of planning a traveling trajectory of the subject vehicle 1 based on the determination information obtained by the environment determination unit 21, the constraints on the path of the subject vehicle 1 in the longitudinal direction, and the constraints on the path of the subject vehicle 1 in the lateral direction. The trajectory planning function may include a function of generating a path plan. The path plan may include a speed plan, or the speed plan may be generated as a plan independent of the path plan. The trajectory planning function may include a function of generating multiple path plans and selecting an optimal path plan from among multiple path plans, or a function of switching the path plans. The trajectory planning function may further include a function of generating backup data of the generated path plan. The trajectory planning function may be a trajectory planning function in the DDT function, and may output the trajectory plan.

The mode management unit 23 monitors the driving system 2 and sets constraints on functions related to driving. The mode management unit 23 may monitor states of subsystems related to the driving system 2 and determine whether the driving system 2 is out of order. The mode management unit 23 may determine a mode based on the driver's intention based on the driver intention estimation information generated by the internal perception unit 14. The mode management unit 23 may set the restriction on the functions related to driving based on at least one of a determination result of the malfunction of the driving system 2, a determination result of the mode, the vehicle state obtained by the internal perception unit 14, a sensor abnormality (or sensor failure) signal output from the sensor 40, state transition information of the application and the trajectory plan obtained by the driving planning unit 22, and the like.

In addition to functional constraints on the driving, the mode management unit 23 may have an entire function of determining the constraints on the path of the subject vehicle 1 in the longitudinal direction and the constraints on the path of the subject vehicle 1 in the lateral direction. In this case, the driving planning unit 22 plans the behavior and plans the trajectory according to the constraints determined by the mode management unit 23.

The control unit 30 includes a motion control unit 31 and an HMI output unit 71 as sub-blocks into which control functions are further classified. The motion control unit 31 controls a motion of the subject vehicle 1 based on the trajectory plan (for example, a path plan and a speed plan) acquired from the driving planning unit 22. Specifically, the motion control unit 31 generates accelerator request information, shift request information, brake request information, and steering request information according to the trajectory plan, and outputs the generated information to the motion actuator 60.

In this case, the motion control unit 31 can directly acquire the vehicle state recognized by the perception unit 10 (particularly, the internal perception unit 14), for example, at least one of a current speed, an acceleration, and a yaw rate of the subject vehicle 1 from the perception unit 10, and can reflect the vehicle state in the motion control of the subject vehicle 1.

The HMI output unit 71 outputs information related to the HMI based on at least one of the determination information and the driver intention estimation information obtained by the environment determination unit 21, the state transition information of the application and the trajectory plan obtained by the driving planning unit 22, the function restriction information obtained by the mode management unit 23, and the like. The HMI output unit 71 may manage a vehicle interaction. The HMI output unit 71 may generate a notification request based on a management state of vehicle interaction, and may control an information notification function of the HMI device 70. Furthermore, the HMI output unit 71 may generate control requests for a wiper, a sensor cleaning device, a headlight, and an air conditioner based on the management state of the vehicle interaction, and control these devices.

### <Scenario>

A scenario base approach may be employed to execute or evaluate a dynamic driving task. As described above, a process required to execute the dynamic driving task in autonomous driving is classified into a disturbance in the perception element, a disturbance in the determination element, and a disturbance in the control element, which have different physical principles. A factor (root cause) affecting a processing result in each element is structured as a scenario structure.

The disturbance in the perception element is a perception disturbance. The perception disturbance is a disturbance that indicates a state in which the perception unit 10 cannot correctly recognize a hazard due to internal or external factors of the sensor 40 and the subject vehicle 1. The internal factors are, for example, instability related to mounting or manufacturing variations in the sensor, such as the external environment sensor 41, tilting of the vehicle due to uneven loads that change a direction of the sensor, and shielding of the sensors by attaching components to the outside of the vehicle. The external factors are, for example, fogging or dirt on the sensor. The physical principles in the perception disturbance are based on a sensor mechanism of each sensor.

The disturbance in the determination element is a traffic disturbance. The traffic disturbance is a disturbance that indicates a potentially hazardous traffic situation that occurs as a result of a combination of the geometry of the road, the behavior of the subject vehicle 1, and the position and behavior of surrounding vehicles. The physical principles in the traffic disturbance are based on the geometrical viewpoint and the behavior of road users.

The disturbance in the control element is a vehicle disturbance. The vehicle disturbance may be referred to as a control disturbance. The vehicle disturbance is a disturbance that indicates a situation in which there is a possibility that the vehicle cannot control its dynamics due to the internal factors or the external factors. The internal factors are, for example, a total weight of the vehicle, a weight balance, and the like. The external factors are, for example, irregularity of a road surface, tilting, wind, and the like. The physical principles of the vehicle disturbance are based on mechanical effects that are input to tires and a vehicle body.

In order to cope with a collision of the subject vehicle 1 with another road user or a structure, which is a risk in a dynamic driving task of the autonomous driving, a traffic disturbance scenario system in which a traffic disturbance scenario is systematized is used as a scenario structure. For the traffic disturbance scenario system, a reasonably foreseeable range or a reasonably foreseeable boundary can be defined, and an avoidable range or an avoidable boundary can be defined.

The avoidable range or the avoidable boundary can be defined, for example, by defining and modeling performance of the competent and careful human driver. The performance of the competent and careful human driver can be defined in three elements of the perception element, the determination element, and the control element.

Examples of the traffic disturbance scenario include a cut-in scenario, a cut-out scenario, and a deceleration scenario. The cut-in scenario is a scenario in which the other vehicle traveling in a lane adjacent to the subject vehicle 1 merges in front of the subject vehicle 1. The cut-out scenario is a scenario in which the other leading vehicle serving as a following target of the subject vehicle 1 changes the lane to an adjacent lane. In this case, it is required to provide a proper response to a falling object that suddenly appears in front of the subject vehicle 1, a stopped vehicle at an end of a traffic congestion, and the like. The deceleration scenario is a scenario in which the other leading vehicle serving as a following target of the subject vehicle 1 suddenly decelerates.

The traffic disturbance scenario may be generated by systematically analyzing and classifying different combinations of a geometry of a road, an operation of the subject vehicle 1, a position of the other vehicle in the surroundings, and an element of an operation of the other vehicle in the surroundings.

As an example of systematizing the traffic disturbance scenario, a structure of the traffic disturbance scenario on an expressway will be described. A road shape is classified into four categories of main road, merging, branching, and ramp. The operation of the subject vehicle 1 is classified into two categories of lane maintenance and lane change. The position of the other vehicle in the surroundings are defined, for example, by adjacent positions in eight directions around the subject vehicle 1 that may intrude into the traveling trajectory of the subject vehicle 1. Specifically, the eight directions indicate leading, following, parallel traveling on the right front side (Pr-f), parallel traveling on the right side (Pr-s), parallel traveling on the right rear side (Pr-r), parallel traveling on the left front side (Pl-f), parallel traveling on the left side (Pl-s), and parallel traveling on the left rear side (Pl-r). The operation of the other vehicle in the surroundings is classified as five categories of cut-in, cut-out, acceleration, deceleration, and synchronization. The deceleration may include stopping.

Among combinations of positions and operations of the other vehicle in the surroundings, there are a combination that may cause a reasonably foreseeable obstacle and a combination that may not cause a reasonably foreseeable obstacle. For example, the cut-in may occur in six categories of parallel traveling. The cut-out may occur in two categories of leading and following. The acceleration may occur in three categories of following, parallel traveling on the right rear side, and parallel traveling on the left rear side. The deceleration may occur in three categories of leading, parallel traveling on the right front side, and parallel traveling on the left front side. The synchronization may occur in two categories of parallel traveling on the right side and parallel traveling on the left side. Accordingly, the traffic disturbance scenario structure in the expressway is formed in a matrix including 40 possible combinations. The structure of the traffic disturbance scenario may be expanded to include a complicated scenario by further considering at least one of a motorcycle and multiple vehicles.

Next, the perception disturbance scenario system will be described. The perception disturbance scenario may include a blind spot scenario (also referred to as an occluded scenario) and a communication disturbance scenario in addition to a sensor disturbance scenario caused by the external environment sensor.

The sensor disturbance scenario may be generated by systematically analyzing and classifying different combinations of factors and sensor mechanism elements.

Among factors of the sensor disturbance, factors related to the vehicle and the sensor are classified into three categories, that is, the subject vehicle 1, the sensor, and a front surface of the sensor. The factor of the subject vehicle 1 is, for example, a change in vehicle posture. The factor of the sensor is, for example, mounting variation, malfunction of a sensor body, or the like. The factor of the front surface of the sensor includes a deposit, a change in characteristics, and reflection in a case of a camera. For these factors, the influence according to the sensor mechanism specific to each external environment sensor 41 may be assumed as a perception disturbance.

Among the factors of the sensor disturbance, the factor related to the external environment is classified into three categories, that is, a surrounding structure, a space, and a surrounding movable object. The surrounding structure is classified into three categories of a road surface, a road side structure, and an upper structure based on a positional relationship with the subject vehicle 1. The factor of the road surface is, for example, a shape, a road surface condition, or a material. The factor of the road side structure is, for example, reflection, shielding, or background. The factor of the upper structure is, for example, reflection, shielding, or background. The factor of the space is, for example, a space obstacle, and radio waves and light in the space.

The factor of the surrounding movable object is, for example, reflection, shielding, or background. For these factors, the influence according to the sensor mechanism specific to each external environment sensor may be assumed as a perception disturbance.

Among the factors of the sensor disturbance, the factors related to a perception target of the sensor are roughly classified into four categories of a traveling road, traffic information, a road obstacle, and a movable object.

The traveling road is classified into a lane marking, a structure having a height, and a road edge based on a structure of an object indicating the traveling road. The road edge is classified into a road edge without steps and a road edge with steps. The factor of the lane marking is, for example, a color, a material, a shape, a stain, scratches, or a relative position. The factor of the structure having a height is, for example, a color, a material, a stain, or a relative position. The factor of the road edge without steps is, for example, a color, a material, a stain, or a relative position. The factor of the road edge with steps is, for example, a color, a material, a stain, or a relative position. For these factors, the influence according to the sensor mechanism specific to each external environment sensor may be assumed as a perception disturbance.

The traffic information is classified into a signal, a sign, and a road marking based on a display form. The factor of the signal is, for example, a color, a material, a shape, a light source, a stain, or a relative position. The factor of the sign is, for example, a color, a material, a shape, a light source, a stain, or a relative position. The factor of the road surface marking is, for example, a color, a material, a shape, a stain, or a relative position. For these factors, the influence according to the sensor mechanism specific to each external environment sensor 41 may be assumed as a perception disturbance.

The road obstacle is classified into a falling object, an animal, and an installed object based on presence or absence of movement and a magnitude of the degree of influence in a case of collision with the subject vehicle 1. The factor of the falling object is, for example, a color, a material, a shape, a size, a relative position, or behavior. The factor of the animal is, for example, a color, a material, a shape, a size, a relative position, or behavior. The factor of the installed object is, for example, a color, a material, a shape, a size, a stain, or a relative position. For these factors, the influence according to the sensor mechanism specific to each external environment sensor 41 may be assumed as a perception disturbance.

The movable object is classified into the other vehicle, a motorcycle, a bicycle, and a pedestrian based on the type of a traffic participant. The factor of the other vehicle is, for example, a color, a material, coating, surface properties, a deposit, a shape, a size, relative position, or behavior. The factor of the motorcycle is, for example, a color, a material, a deposit, a shape, a size, a relative position, or behavior. The factor of the bicycle is, for example, a color, a material, a deposit, a shape, a size, a relative position, or behavior. The factor of the pedestrian is, for example, a color and a material worn on the body, a posture, a shape, a size, a relative position, or behavior. For these factors, the influence according to the sensor mechanism specific to each external environment sensor 41 may be assumed as a perception disturbance.

The sensor mechanism that causes the perception disturbance is classified into perception processing and others. The disturbance caused in the perception processing is classified into a disturbance related to a signal from the perception target object and a disturbance that interferes the signal from the perception target object. The disturbance that interferes the signal from the perception target object is, for example, noise or an unnecessary signal.

Particularly in camera perception processing, physical quantities that characterize a signal of the perception target object include, for example, an intensity, an azimuth, a range, a change in signal, and an acquisition time. Regarding noise and the unnecessary signal, there are a case where the contrast is low and a case where the noise is large.

Particularly in LiDAR perception processing, physical quantities that characterize the signal of a perception target object include, for example, a scan timing, an intensity, a propagation direction, and a speed. The noise and the unnecessary signal are, for example, DC noise, pulse noise, multiple reflections, and reflections or refraction from objects other than the perception target object.

Particularly in millimeter wave radar, other disturbances include disturbances caused by the orientation of the sensor. In millimeter wave radar perception processing, physical quantities that characterize the signal of the perception target object are, for example, a frequency, a phase, and an intensity. The noise and the unnecessary signal are, for example, small signal disappearance due to a circuit signal, a phase noise component of an unnecessary signal or signal embedding due to radio wave interference, and an unnecessary signal from a source other than the perception target.

The blind spot scenario is classified into three categories of the other vehicle in the surroundings, a road structure, and a road shape. In the blind spot scenario caused by the other vehicle in the surroundings, the other vehicle in the surroundings may induce a blind spot that also affects the other vehicle. Therefore, a position of the other vehicle in the surroundings may be based on an expansion definition in which adjacent positions in eight surrounding directions are expanded. In the blind spot scenario due to the other vehicle in the surroundings, possible blind spot vehicle motion is classified into cut-in, cut-out, acceleration, deceleration, and synchronization.

The blind spot scenario due to the road structure is defined by considering the position of the road structure and the relative motion pattern between the subject vehicle 1 and other vehicles existing in the blind spot or virtual other vehicles assumed to be in the blind spot. The blind spot scenario of the road structure is classified into a blind spot scenario caused by an external barrier and a blind spot scenario caused by an internal barrier. For example, the external barrier generates a blind spot region in curves.

The blind spot scenario based on the road shape is classified into a longitudinal gradient scenario and an adjacent lane gradient scenario. The longitudinal gradient scenario generates a blind spot region in one or both the front and rear of the subject vehicle 1. The adjacent lane gradient scenario generates a blind spot region on a merging path, a branch path, and the like due to a height difference with the adjacent lane.

The communication disturbance scenario is classified into three categories of a sensor, an environment, and a transmitter. The communication disturbance related to the sensor is classified into a map factor and a V2X factor. The communication disturbance related to the environment is classified into a static entity, a space entity, and a dynamic entity. The communication disturbance related to the transmitter is classified into the other vehicle, an infrastructure, a pedestrian, a server, and a satellite.

Next, a vehicle disturbance scenario system will be described. The vehicle disturbance scenario is classified into two categories of a vehicle body input and a tire input. The vehicle body input is an input in which an external force acts on the vehicle body and affects the motion in at least one of the longitudinal direction, the lateral direction, and the yaw direction. The element that affects the vehicle body is classified into a road shape and a natural phenomenon. The road shape is, for example, a superelevation of a curved portion, a longitudinal gradient, a curvature, and the like. Examples of natural phenomenon include crosswinds, tailwinds, and headwinds.

The tire input is an input that changes a force generated by the tire and affects the motion in at least one of the longitudinal direction, the lateral direction, the vertical direction, and the yaw direction. The element that affects the tire is classified into a road surface condition and a tire state.

The road surface condition is, for example, a friction coefficient between the road surface and the tires, an external force applied to the tires, or the like. The road surface factor that affects the friction coefficient is classified into, for example, a wet road, a frozen road, a snowy road, a partial gravel, a road surface marking, or the like. The road surface factor that affects the external force on the tires is, for example, a pothole, a protrusion, a step, a rut, a joint, grooving, or the like. The tire state is, for example, puncture, burst, tire wear, or the like.

The scenario DB 53 may include at least one of a functional scenario, a logical scenario, and a concrete scenario. The functional scenario defines a top-level qualitative scenario structure. The logical scenario is a scenario in which a quantitative parameter range is allocated to the structured functional scenario. The concrete scenario defines a boundary of safety determination that distinguish between a safe state and an unsafe state.

The unsafe state is, for example, a hazardous situation. In addition, a range corresponding to the safe state may be referred to as a safe range, and a range corresponding to the unsafe state may be referred to as an unsafe range. Furthermore, a condition that contributes to the inability to prevent, detect, and mitigate hazardous behavior or reasonably foreseeable misuse of the subject vehicle 1 in a scenario may be a triggering condition.

The scenario can be classified as known or unknown, and hazardous or non-hazardous. That is, the scenario can be classified into a known hazardous scenario, a known non-hazardous scenario, a unknown hazardous scenario, and a unknown non-hazardous scenario.

The scenario DB 53 may be used for determination regarding the environment in the driving system 2 as described above, but may also be used for verification and validation of the driving system 2. The method for verifying and validating the driving system 2 may be referred to as the evaluation method of the driving system 2.

### <Safety and Security>

The driving system 2 estimates a situation and controls behavior of the subject vehicle 1. The driving system 2 is configured to avoid accidents and hazardous situations leading to accidents as much as possible, and to maintain a safe situation or safety. The hazardous situations may be caused as a result of the maintenance state of the subject vehicle 1 or a failure of the driving system 2. The hazardous situations may also be caused from outside such as another road user. The driving system 2 is configured to maintain safety by changing the behavior of the subject vehicle 1 by reacting to an event in which a safe situation cannot be maintained due to external factors such as another road user.

The driving system 2 has control performance that stabilizes the behavior of the subject vehicle 1 in a safe state. The safe state depends not only on the behavior of the subject vehicle 1 but also on the situation. When the behavior of the subject vehicle 1 cannot be controlled to stabilize in a safe state, the driving system 2 behaves such that the harm or risk of an accident is minimized. In this case, the harm caused by an accident may mean damage caused to traffic participants (road users) when a collision occurs, or the magnitude of damage. Risk may be based on the magnitude and likelihood of harm, for example, a product of magnitude and likelihood of harm.

A behavior, or the best way to derive that behavior, that minimizes the harm or risk of an accident may be referred to as best effort. The best effort may include a best effort that can guarantee that the automated driving system minimizes the severity or risk of an accident (hereinafter referred to as “best effort that can guarantee minimum risk”). The guaranteed best effort may mean a minimal risk maneuver (MRM) or a DDT fallback. Although the best effort cannot guarantee the minimization of the harm or risk of an accident, the best effort may include a best effort that attempts to reduce and minimize the severity or risk of the accident to the extent that is controllable (hereinafter referred to as “best effort that cannot guarantee minimum risk).

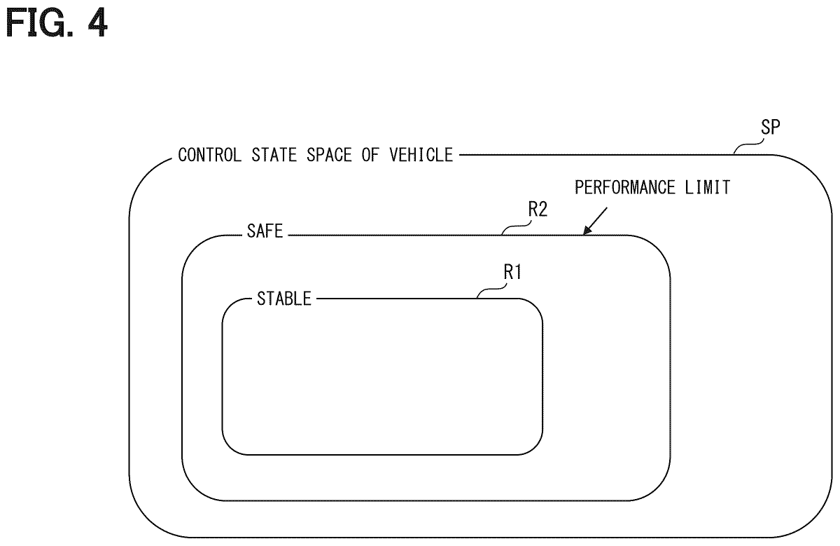

FIG. 4 illustrates a control state space SP that spatially represents a control state of the vehicle. The driving system 2 may have a control performance that stabilizes the behavior of the subject vehicle 1 within a range that has a margin on the safe side of a performance limit of the system that can ensure safety. The performance limit of the system that can ensure safety may be a boundary between the safe state and the unsafe state, that is, the boundary between the safe range and the unsafe range. An operational design domain (ODD) in the driving system 2 is typically set within a performance limit range R2, and more preferably outside a stable controllable range R1.

A range that has a margin on the safe side of the performance limit may be referred to as a stable range. In the stable range, the driving system 2 can maintain the safe state through a nominal operation as designed. A state in which a safe state can be maintained through nominal operation as designed may be referred to as a stable state. The stable state can provide “usual safety” to the occupant and others. The stable range may be referred to as the stable controllable range R1 in which stable control is possible.

Furthermore, outside the stable controllable range R1 and within the performance limit range R2, the driving system 2 can return control to the stable state on the premise that environmental assumptions hold. This environmental assumption may be, for example, a reasonably foreseeable assumption. For example, the driving system 2 can react to the behavior of the reasonably foreseeable road user, and the like to change the behavior of the subject vehicle 1 and avoid falling into a hazardous situation, and can return to stable control again. A state in which the control can return to the stable state can provide “safety in case of emergency” to the occupant and the like.

In the driving system 2, the determination unit 20 may determine whether to continue stable control within the performance limit range R2 (in other words, before it goes outside the performance limit range R2), or to transition to the minimal risk condition (MRC). The minimal risk condition may be a fallback condition. The determination unit 20 may determine whether to continue stable control or transition to the minimal risk condition outside the stable controllable range R1 and within the performance limit range R2. The transition to the minimal risk condition may be an execution of MRM or a DDT fallback.

For example, when an automated driving system of Level 3 executes autonomous driving, the determination unit 20 may transfer authority to the driver, for example, take over. The control may be adopted to execute the MRM or DDT fallback when driving is not taken over from the automated driving system to the driver.

The determination unit 20 may determine the state transition of driving action based on the situation estimated by the environment determination unit 21. The state transition of driving action may mean a transition of behavior of the subject vehicle 1 that is implemented by the driving system 2, for example, a transition between behavior for maintaining consistency and predictability of rules and reaction behavior of the subject vehicle 1 according to external factors such as another road user. That is, the state transition of driving action may be a transition between an action and a reaction. In addition, determination of the state transition of driving action may be a determination whether to continue the stable control or to transition to the minimal risk condition. The stable control may mean a state in which the behavior of the subject vehicle 1 does not fluctuate, suddenly accelerate, suddenly brake, and the like, or has an extremely low occurrence frequency. The stable control may mean control at a level that allows a human driver to recognize that the behavior of the subject vehicle 1 is stable or that there are no abnormalities.

The situation estimated by the environment determination unit 21, that is, the situation estimated by the electronic system, may include differences from the real world. Therefore, the performance limit in the driving system 2 may be set based on the allowable range of difference from the real world. In other words, the margin between the performance limit range R2 and the stable controllable range R1 may be defined based on a difference between the situation estimated by the electronic system and the real world. The difference between the situation estimated by the electronic system and the real world may be an example of the influence or error due to the disturbance.

A situation used for determining the transition to the minimal risk condition may be recorded in the recording device 55 in a format estimated by the electronic system, for example. In MRM or DDT fallback, for example, when there is an interaction between the electronic system and the driver through the HMI device 70, an operation of the driver may be recorded in the recording device 55.

### <Interaction in Driving System>

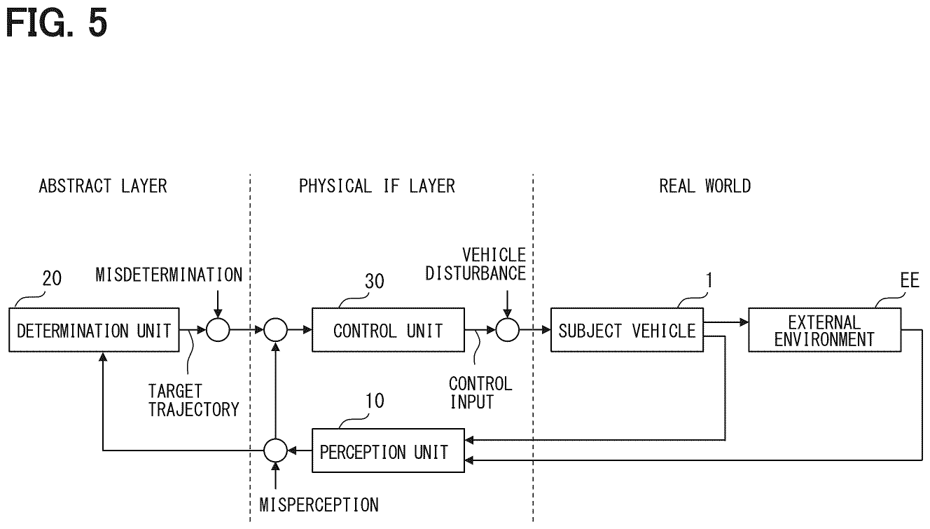

The architecture of the driving system 2 can be represented by a relationship between an abstract layer, a physical interface layer (hereinafter referred to as a physical IF layer), and the real world. In this case, the abstract layer and the physical IF layer may mean a layer configured by an electronic system. As shown in p FIG. 5, the interaction between the perception unit 10, the determination unit 20, and the control unit 30 can be represented by a block diagram showing a causal loop.

In detail, the subject vehicle 1 in the real world affects the external environment EE. The perception unit 10 belonging to the physical IF layer recognizes the subject vehicle 1 and the external environment EE. In the perception unit 10, an error or a deviation may be generated due to misperception, observation noise, perception disturbance, and the like. The error or deviation occurring in the perception unit 10 affects the determination unit 20 belonging to the abstract layer. In addition, on the premise that the control unit 30 acquires the vehicle state for controlling the motion actuator 60, the error or deviation occurring in the perception unit 10 directly affects the control unit 30 belonging to the physical IF layer without through the determination unit 20. In the determination unit 20, misdetermination, traffic disturbance, and the like may be generated. The error or deviation occurring in the determination unit 20 affects the control unit 30 belonging to the physical IF layer. When the control unit 30 controls the motion of the subject vehicle 1, a vehicle disturbance occurs. Furthermore, the subject vehicle 1 in the real world affects the external environment EE, and the perception unit 10 recognizes the subject vehicle 1 and the external environment EE.

In this way, the driving system 2 has a causal loop structure configured to straddle between the respective layers. Furthermore, the driving system 2 has a causal loop structure configured to go back or forth between the real world, the physical IF layer, and the abstract layer. The errors or deviations occurring in the perception unit 10, the determination unit 20, and the control unit 30 may propagate along the causal loop.

The causal loop is classified into an open loop and a closed loop. The open loop can also be said to be a partial loop that takes out of a part of the closed loop. The open loop is, for example, a loop composed of the perception unit 10 and the determination unit 20, a loop composed of the determination unit 20 and the control unit 30, or the like.

The closed loop is a closed loop configured to circulate between the real world and at least one of the physical IF layer and the abstract layer. The closed loop is classified into an inner loop IL that is completed in the subject vehicle 1, and an outer loop EL that includes an interaction between the subject vehicle 1 and the external environment EE.

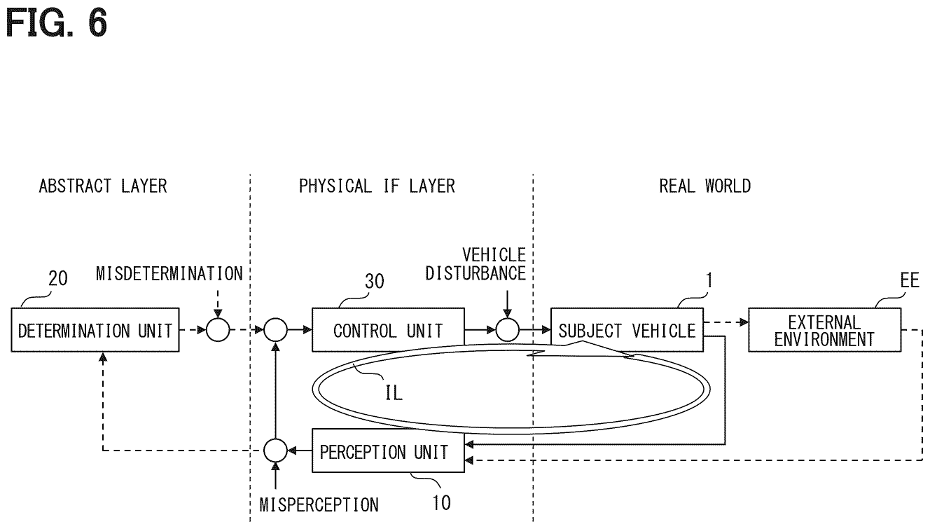

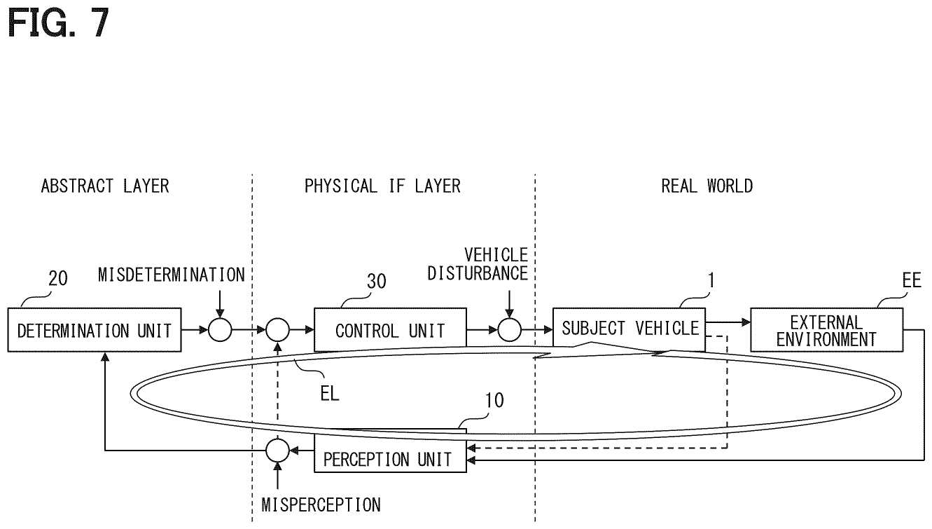

For example, in FIG. 6, the inner loop IL is a loop that returns from the subject vehicle 1 to the subject vehicle 1 through the perception unit 10 and the control unit 30. As described above, parameters that directly affect the control unit 30 from the perception unit 10 is a vehicle state such as vehicle speed, acceleration, and yaw rate as one premise, and do not include perception results of the external environment sensor 41, so that the inner loop IL can be said to be a loop that is completed in the subject vehicle 1. For example, in FIG. 7, the outer loop EL is a loop that returns from the subject vehicle 1 to the subject vehicle 1 through the external environment EE, the perception unit 10, the determination unit 20, and the control unit 30.

### <Verification and Validation>

Verification and validation of the driving system 2 may include evaluation of at least one, preferably all, of the following functions and abilities. The evaluation target herein may be referred to as a verification target or a validation target.

For example, an evaluation target related to the perception unit 10 is functionality of a sensor or external data source (for example, map data source), functionality of a sensor processing algorithm that models an environment, and reliability of an infrastructure and a communication system.

For example, the evaluation target related to the determination unit 20 is the ability of the determination algorithm. The ability of the determination algorithm includes an ability to safely handle potential deficiencies, and an ability to make appropriate determinations according to the environment model, driving policy, current destination, or the like. For example, the evaluation targets related to the determination unit 20 include the absence of unreasonable risks due to hazardous behavior of the intended function, the function of the system to safely handle ODD use cases, a robust performance of execution of the entire ODD driving policy, suitability for DDT fallback, and suitability for minimal risk conditions.

For example, the evaluation target is a robust performance of the system or function. The robust performance of a system or function is a robust performance of the system to adverse environmental conditions, suitability of system operation to known triggering conditions, sensitivity of the intended function, an ability to monitor various scenarios, or the like.

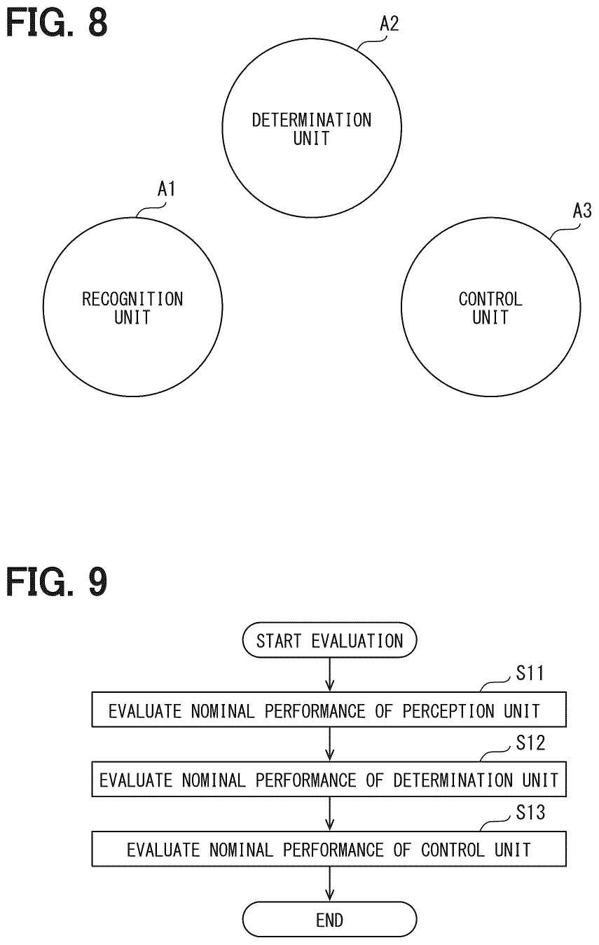

Next, several examples of the evaluation method of the driving system 2 will be specifically described with reference to FIGS. 8 to 13. The evaluation method herein may be a configuration method of the driving system 2 or a design method of the driving system 2. FIGS. 8, 10, and 12 below show each circle A1, A2, and A3 is a virtual and schematic representation of a region in which safety cannot be maintained due to each of the perception unit 10, determination unit 20, and control unit 30.

A first evaluation method is a method for independently evaluating the perception unit 10, the determination unit 20, and the control unit 30 as shown in FIG. . That is, the first evaluation method includes individual evaluation on a nominal performance of the perception unit 10, a nominal performance of the determination unit 20, and a nominal performance of the control unit 30. The individual evaluation may mean evaluation on the perception unit 10, the determination unit 20, and the control unit 30 each other based on mutually different viewpoints and means.

For example, the control unit 30 may be evaluated based on control theory. The determination unit 20 may be evaluated based on a logical model that proves safety. The logical model may be a responsibility sensitive safety (RSS) model, a safety force field (SFF) model, or the like.

The perception unit 10 may be evaluated based on a perception failure rate. For example, the evaluation criterion may be whether the perception result of the entire perception unit 10 is less than or equal to a target perception failure rate. The target perception failure rate for the entire perception unit 10 may be a value less than a statistically calculated collision encounter rate by the human driver. The target perception failure rate may be, for example, 10⁻⁹, which is a probability of two orders of lower than an accident encounter rate. The perception failure rate herein is a value standardized such that the perception failure becomes 1 in the case of 100% failure.

Furthermore, when multiple subsystems (for example, camera subsystems, subsystems of the external environment sensor 41 excluding the camera, and map subsystems) are configured by multiple sensors 40, the reliability may be ensured by majority decision of multiple subsystems. Assuming the majority decision of the subsystems, the target perception failure rate for each subsystem may be a value greater than the target perception failure rate of the entire perception unit 10. The target perception failure rate for each subsystem may be, for example, 10⁻⁵. In the first evaluation method, a target value or target condition may be set based on a positive risk balance.

An example of the first evaluation method will be described using the flowchart of FIG. 9. The implementing entity in each step of S11 to S13 is at least one of, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, a testing organization or authentication organization for the driving system 2, or the like. In the case where the evaluation is performed by simulation, the actual implementing entity may be at least one processor. In each step of S11 to S13, the implementing entity may be a common entity or a different entity.

In S11, the nominal performance of the perception unit 10 is evaluated. In S12, the nominal performance of the determination unit 20 is evaluated. In S13, the nominal performance of the control unit 30 is evaluated. The order of S11 to S13 can be changed as appropriate, and S11 to S13 can be performed simultaneously.

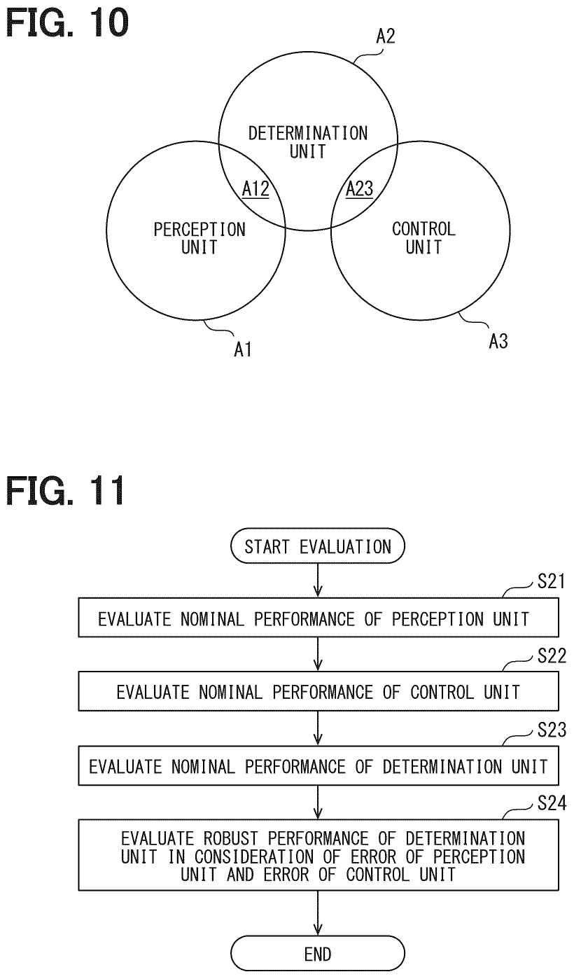

As shown in FIG. 10, the second evaluation method includes evaluating the nominal performance of the determination unit 20, and evaluating the robust performance of the determination unit 20 in consideration of at least one of the error of the perception unit 10 and the error of the control unit 30. As the premise of this evaluation method, the second evaluation method may further include evaluating the nominal performance of the perception unit 10 and evaluating the nominal performance of the control unit 30. The nominal performance of the determination unit 20 may be evaluated based on the above-described traffic disturbance scenario.

The robust performance of the determination unit 20 may be evaluated by verifying a traffic disturbance scenario in which an error range has been specified using a physically-based error model that represents the error of the perception unit 10, such as an error of the sensor. For example, the traffic disturbance scenario is evaluated under an environmental condition in which a recognized disturbance occurs. Accordingly, in the second evaluation method, a region A12 that overlaps circle A1 of the perception unit 10 and circle A2 of the determination unit 20 as shown in FIG. 10, in other words, a composite factor of the perception unit 10 and the determination unit 20 may be included in the evaluation target. The evaluation of the composite factors by the perception unit 10 and the determination unit 20 may be implemented by open loop evaluation directly from the perception unit 10 to the determination unit 20 in the above-mentioned causal loop.

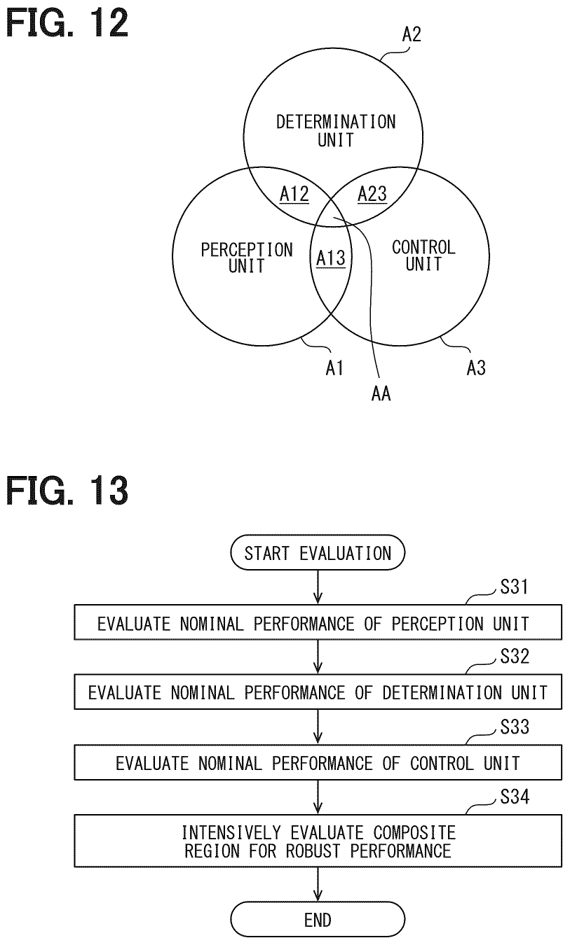

The robust performance of the determination unit 20 may be evaluated by verifying a traffic disturbance scenario in which an error range is specified using a physically-based error model that represents the error of the control unit 30, such as a vehicle motion error. For example, the traffic disturbance scenario is evaluated under an environmental condition in which a vehicle disturbance occurs. As a result, in the second evaluation method, a region A23 that overlaps circle A2 of the determination unit 20 and circle A3 of the control unit 30 as shown in FIG. 12, in other words, a composite factor of the determination unit 20 and the control unit 30 may be included in the evaluation target. The evaluation of the composite factor of the determination unit 20 and the control unit 30 may be implemented by open loop evaluation directly from the determination unit 20 to the control unit 30 in the causal loop described above.

An example of the second evaluation method will be described using the flowchart of FIG. 11. The implementing entity in each step of S21 to S24 is at least one of, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, a testing organization or authentication organization for the driving system 2, or the like. In the case where the evaluation is performed by simulation, the actual implementing entity may be at least one processor. In each step of S21 to S24, the implementing entity may be a common entity or a different entity.

In S21, the nominal performance of the perception unit 10 is evaluated. In S22, the nominal performance of the control unit 30 is evaluated. In S23, the nominal performance of the determination unit 20 is evaluated. In S24, the robust performance of the determination unit 20 is evaluated in consideration of the error of the perception unit 10 and the error of the control unit 30. The order of S21 to S24 can be changed as appropriate, and S21 to S24 can be performed simultaneously.

As shown in FIG. 12, in the third evaluation method, regions A12, A23, A13, and AA that overlap at least two of circle A1 of the perception unit 10, circle A2 of the determination unit 20, and circle A3 of the control unit 30 are included in the evaluation target. First, the third evaluation method includes evaluating the nominal performance of the perception unit 10, the nominal performance of the determination unit 20, and the nominal performance of the control unit 30. The first evaluation method itself or a part of the first evaluation method may be adopted for the evaluation of the nominal performance. On the other hand, a method completely different from the first evaluation method may be adopted for evaluating the nominal performance.

Furthermore, the third evaluation method includes intensively evaluating a composite factor in which at least two of the perception unit 10, the determination unit 20, and the control unit 30 are composed for a robust performance of the perception unit 10, a robust performance of the determination unit 20, and a robust performance of the control unit 30. The composite factors of at least two of the perception unit 10, the determination unit 20, and the control unit 30 are a composite factor of the perception unit 10 and the determination unit 20, a composite factor of the determination unit 20 and the control unit 30, a composite factor of the perception unit 10 and the control unit 30, and three composite factors of the perception unit 10, the determination unit 20, and the control unit 30.

The intensively evaluating of the composite factor may include extracting, for example, a specific condition in which an interaction between the perception unit 10, the determination unit 20, and the control unit 30 is relatively large based on the scenario, and evaluating the specific condition in more detail as compared with another condition in which the interaction is relatively small. The evaluating in more detail may include at least one of evaluating the specific condition in more detail as compared with another condition and evaluating the specific condition by increasing the number of tests. The condition serving as the evaluation target (for example, the above-described specific condition and another condition) may include a triggering condition. In this case, the magnitude of the interaction may be specified using the above-described causal loop.

Some of the evaluation methods described above may include defining an evaluation target, designing a test plan based on the definition of the evaluation target, and executing the test plan to show an absence of unreasonable risks caused by known or unknown hazardous scenarios. The test may be either a physical test, a simulation test, or a combination of the physical test and the simulation test. The physical test may be, for example, a field operational test (FOT). A target value in FOT may be set in the form of an allowable number of failures for a predetermined travel distance (for example, tens of thousands of km) of a test vehicle using FOT data or the like.

An example of the third evaluation method will be described using the flowchart of FIG. 13. The implementing entity in each step of S31 to S34 is at least one of, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, a testing organization or authentication organization for the driving system 2, or the like. In the case where the evaluation is performed by simulation, the actual implementing entity may be at least one processor. In each step of S31 to S34, the implementing entity may be a common entity or a different entity.

In S31, the nominal performance of the perception unit 10 is evaluated. In S32, the nominal performance of the determination unit 20 is evaluated. In S33, the nominal performance of the control unit 30 is evaluated. In S34, composite regions A12, A23, A13, and AA are intensively evaluated for the robust performance. The order of S31 to S34 can be changed as appropriate, and S31 to S34 can be performed simultaneously.

### <Evaluation Strategy of Driving System>

An evaluation strategy of the driving system 2 includes a preliminary evaluation strategy and a post evaluation strategy. The preliminary evaluation strategy may include selecting an optimal method for enhancing or ensuring at least one of the performance and validity of the driving system 2 from among multiple evaluation methods such as the first evaluation method, the second evaluation method, and the third evaluation method described above, and other evaluation methods.

The preliminary evaluation strategy may be a strategy of independently evaluating each of the perception unit 10, determination unit 20, and control unit 30, as shown in the first evaluation method. This strategy can be implemented using an approach to evaluate the nominal performance with the open loop.

The preliminary evaluation strategy may be a strategy that intensively evaluates a composite factor caused by a combination of the perception unit 10 and determination unit 20 and a composite factor caused by a combination of the determination unit 20 and control unit 30, as shown in the second evaluation method. This strategy can be implemented by including an approach to evaluate the robust performance with the open loop.

The preliminary evaluation strategy may be a strategy that intensively evaluates a composite factor caused by a combination of the control unit 30 and the perception unit 10 and a composite factor caused by a combination of the perception unit 10, the determination unit 20, and the control unit 30. This strategy can be implemented by including an approach to evaluate a robust performance with the closed loop in the embodiment of the third evaluation method. More specifically, the evaluation of the composite factor caused by the combination of the control unit 30 and the perception unit 10 can be implemented by performing the evaluation with the inner loop IL that is completed in the subject vehicle 1. The evaluation of the composite factor caused by the combination of the perception unit 10, the determination unit 20, and the control unit 30 can be implemented by performing the evaluation with the outer loop EL including the interaction between the subject vehicle 1 and the external environment EE.

In the following, some specific examples of an evaluation method for evaluating a robust performance with the closed loop, a design method of the driving system 2 using the evaluation method, and the driving system 2 that is implemented by the evaluation method and the design method will be described in detail.

### <Allocation of Reliability/Allocation of Allowable Error>

A first design method is a design method that takes into account the sharing of responsibility of each subsystem (that is, the perception system 10a, the determination system 20a, and the control system 30a), and is a design method based on allocation of reliability to each subsystem. When the composite factor is evaluated, it is preferable to use a unified index between each of the subsystems. An example of the unified index is reliability.

Therefore, in this design method and the evaluation method used in the design, reliability may be newly introduced as an index for evaluating the control unit 30. A concept of probability robust control is introduced such that the driving system 2 sets the allowable error to be less than or equal to ε with a probability that is greater than or equal to the reliability (1-δ). The concept of the probability robust control may be an example of driving policy. Accordingly, when the evaluation based on a combination of the reliability and the allowable error is used, it is possible to avoid the need to calculate the probability distribution of error propagating through each of the perception unit 10, the determination unit 20, and the control unit 30. Therefore, a load on evaluation can be reduced.

The reliability of the driving system 2 may be set based on technical or social grounds. For example, the reliability of the driving system 2 may be set to a value that is less than or equal to the statistically calculated collision encounter rate caused by the human driver.

In the probability robust control, the reliability has a greater influence on comfort than the error. The error has a great influence on safety than the reliability. The reliability and the error are separately evaluated, so that the comfort and safety of the driving system 2 can be optimized. The reliability is allocated to each subsystem based on the specification of safety required for the driving system 2. Therefore, the first design method based on the allocation of reliability can be said to be a top-down design method that attempts to incorporate the specification of the entire driving system 2 into the specification of each subsystem.

When the reliability required for the driving system 2 is directly used as the reliability of each subsystem, the performance required for each subsystem becomes high. Therefore, by allocating or distributing the reliability of the driving system 2 to each subsystem, it is possible to avoid requiring excessive performance from each subsystem.

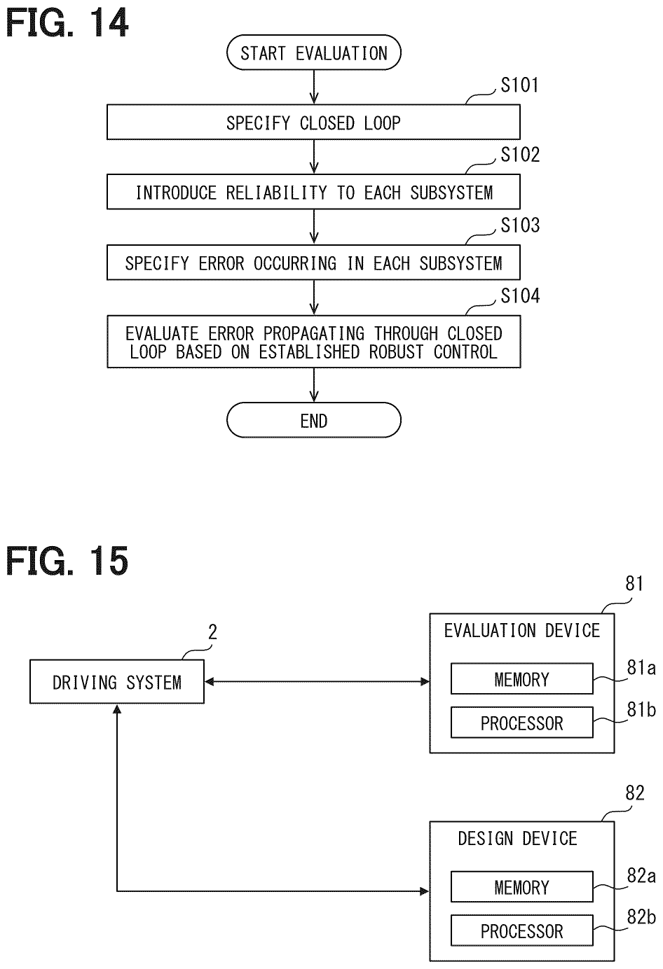

An example of the evaluation method used in the first design method will be described using the flowchart of FIG. 14. The implementing entity in each step of S101 to S104 is at least one of, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, a testing organization or authentication organization for the driving system 2, or the like. When the evaluation is performed by simulation, the actual implementing entity may be an evaluation device 81 or a design device 82 as shown in FIG. 15, for example. In each step of S101 to S104, the implementing entity may be a common entity or a different entity.

The evaluation device 81 includes at least one memory 81a and at least one processor 81b, and at least one processor 81b executes a program stored in the memory 81a, thereby implementing an evaluation function. The memory 81a may be at least one type of non-transitory tangible storage medium among, for example, a semiconductor memory, a magnetic medium, and an optical medium that non-temporarily store programs, data, and the like that can be read by a computer (here, for example, a processor 81b). The processor 81b includes, as a core, at least one type of, for example, a central processing unit (CPU), a graphics processing unit (GPU), and a reduced instruction set computer (RISC)-CPU. Furthermore, the evaluation device 81 may include an interface that enables communication while being connected to the driving system 2 or another computer provided outside a device that reproduces the architecture of the driving system 2 during evaluation. In addition, the evaluation device 81 may further include a scenario DB 53 used to define a simulation premise during evaluation.

The design device 82 includes at least one memory 82a and at least one processor 82b, and at least one processor 82b executes a program stored in the memory 82a, thereby implementing a design function. The memory 82a may be at least one type of non-transitory tangible storage medium among, for example, a semiconductor memory, a magnetic medium, and an optical medium that non-temporarily store programs, data, and the like that can be read by a computer (here, for example, a processor 82b). The processor 82b includes, as a core, at least one type of, for example, a central processing unit (CPU), a graphics processing unit (GPU), and a reduced instruction set computer (RISC)-CPU. The design function may include an evaluation function. Furthermore, the design device 82 may include an interface capable of communicating with another computer provided outside the device that reproduces the architecture of the driving system 2. In addition, the design device 82 may further include a scenario DB 53 used to define a simulation premise during evaluation. The memories 81a and 82a may be implemented in the form of storage media that are provided independently outside the devices 81 and 82 and configured to be readable by another computer.

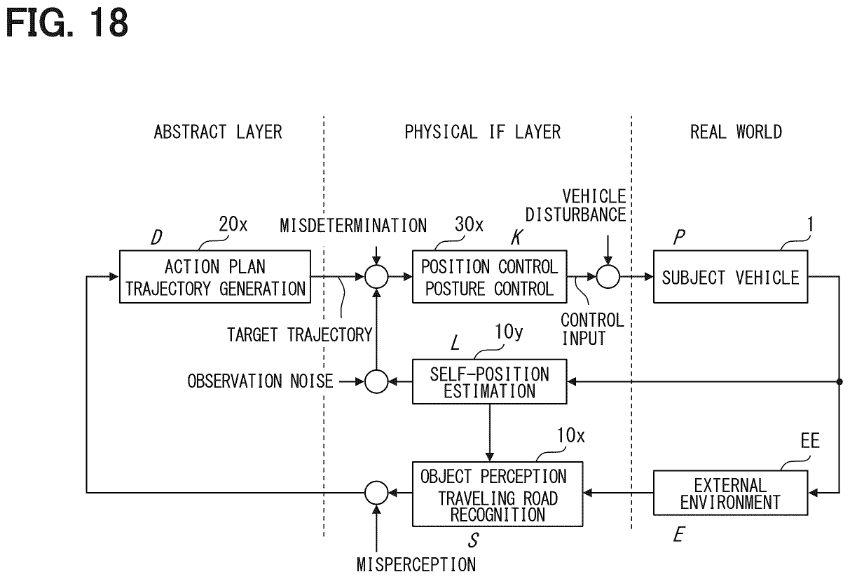

In S101, an interaction between each subsystem and the real world is modeled as a loop structure. Based on the architecture of the driving system 2 serving as the evaluation target, for example, a causal loop that straddles the abstract layer, the physical IF layer, and the real world in FIG. 5 is modeled. The causal loop may be modeled in more detail such that the complexity of the architecture is more faithfully reproduced (see example in FIG. 18).

Accordingly, at least one closed loop is specified. For example, as shown in FIGS. 6 and 7, two closed loops of the outer loop EL and the inner loop IL, are specified. After S101, the process proceeds to S102.

In S102, the reliability as a unified index is introduced into each subsystem. After S102, the process proceeds to S103.

In S103, an error occurring in each subsystem is specified. For example, as shown in FIG. 5, the error occurring in the perception unit 10 due to misperception, the error occurring in the determination unit 20 due to misdetermination, and the error occurring in the control unit 30 due to the vehicle disturbance are specified. These errors may include an error based on quantitative errors and an error based on qualitative errors, as described below. These errors may be specified individually for each scenario based on the scenario base approach described above. These errors may be specified based on the relationship with ODD.

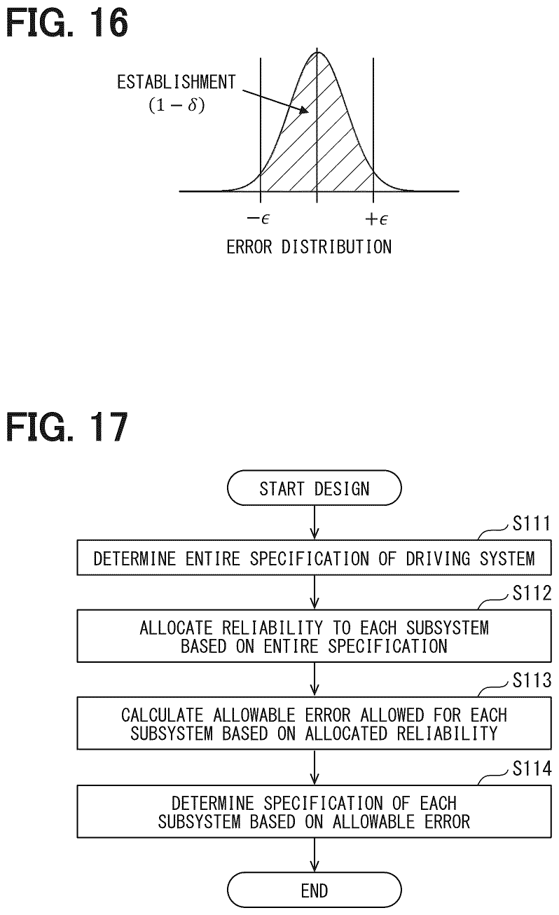

As shown in FIG. 16, for these errors, an error boundary value ε, which serves as a probability 1-δ corresponding to reliability, may be set in a probability density function representing an error distribution. After S103, the process proceeds to S104.

In S104, the closed loop specified in S101 is evaluated based on the reliability introduced in S102. When multiple closed loops are specified, evaluation may be performed on all of the closed loops. On the other hand, some closed loop evaluations that have a little degree of influence as composite factors may be omitted.

The closed loop evaluation based on the reliability is, for example, evaluating an error propagating through the closed loop based on the probability robust control. That is, it can be evaluated that the error propagating in accordance with the closed loop falls within the allowable error with a probability greater than or equal to a predetermined reliability. This evaluation may be performed using Equations 1 to 4, which will be described later. The series of evaluations ends at S104. The order of S101 to S103 can be changed as appropriate, and S101 to S103 can be performed simultaneously.

Next, an example of the first design method will be described using the flowchart of FIG. 17. The implementing entity in each step of S111 to S114 may be, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, or the like. The implementing entity may be the design device 82. In each step of S111 to S114, the implementing entity may be a common entity or a different entity.

In S111, the entire specification of the driving system 2 is determined. The entire specification herein may include the entire architecture of the driving system 2 based on components constituting the driving system 2. The entire specification does not need to include detailed specifications of the components of the subsystem, such as detailed specifications of the camera. After S111, the process proceeds to S112.

In S112, the reliability is allocated to each subsystem of the perception system 10a, the determination system 20a, and the control system 30a, based on the entire specification of the driving system 2 determined in S111. The reliability may be allocated as a uniform fixed value regardless of ODD, scenario, and the like. This allocation may be referred to as static allocation.

On the other hand, individual values may be allocated to each allocation category such as ODD or scenario. This allocation may be referred to as dynamic allocation. For example, when excessive reliability is required for the perception system 10a in the perception disturbance scenario, an extremely high performance is required as a specification for the external environment sensor 41, leading to an increase in the cost of the driving system 2. Therefore, in the perception disturbance scenario, the allocation may be made such that the reliability of the perception system 10a is lowered and the reliability of the determination system 20a and the control system 30a is increased accordingly.

The allocation category may be further subdivided. For example, in the communication disturbance scenario of the perception disturbance scenarios, information in the map DB 44 may not be updated to the latest information. In this case, it is difficult to obtain excessive reliability from the map DB 44. Therefore, the allocation may be changed such that the reliability allocated to the map DB 44 is lowered and the reliability allocated to other external environment sensors 41 such as cameras, or the determination system 20a and the control system 30a may be improved, for example. After S112, the process proceeds to S113.

In S113, the error distribution or allowable error allowed to each subsystem is calculated based on the reliability allocated in S112. In calculating the error distribution or allowable error, the closed loop evaluation method shown in S101 to S104 may be used. After S113, the process proceeds to S114.

In S114, the specification of each subsystem is determined based on the error distribution or allowable error calculated in S113. That is, each subsystem is designed such that the error distribution or allowable error allowed for each subsystem is achieved. The series of processes ends at S114.

The second design method is a design method using sensitivity of the driving system 2, and is a design method based on the allocation of allowable error to each subsystem. This design method includes evaluating an error propagating in a causal loop structure shown in FIGS. 5 and 14, for example.

For example, the causal loop structure in FIG. 18 is a more specific version of the causal loop structure in FIG. 5. A self-position estimation block 10y in FIG. 18 corresponds to the self-position perception unit 12 and the internal perception unit 14 of the perception unit 10. An object perception/traveling road perception block 10x corresponds to the external perception unit 11 and the fusion unit 13 of the perception unit 10. An action plan/trajectory generation block 20x corresponds to the determination unit 20. A position control/posture control block 30x corresponds to the motion control unit 31 of the control unit 30.

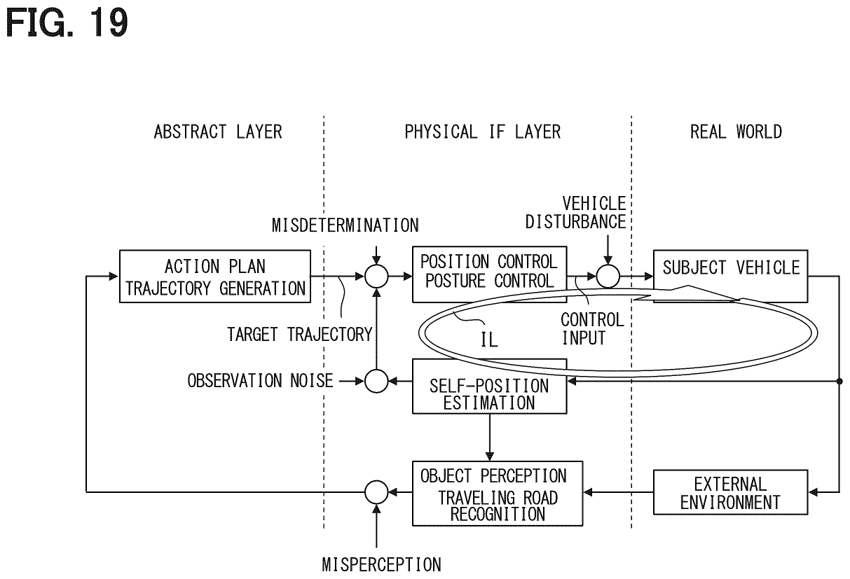

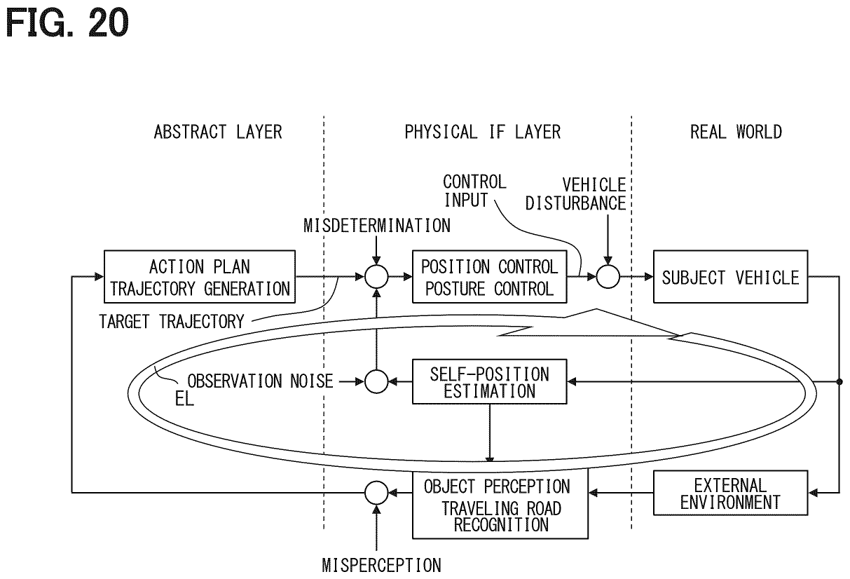

Even in this causal loop structure, there is an inner loop IL that is completed in the subject vehicle 1 in the closed loop, and an outer loop EL that includes the interaction between the subject vehicle 1 and the external environment EE. The inner loop IL shown in FIG. 19 is a loop that returns from the subject vehicle 1 to the subject vehicle 1 through the self-position estimation block 10y and the position control/posture control block 30x. The outer loop EL shown in FIG. 20 is a loop that returns from the subject vehicle 1 to the subject vehicle 1 through the external environment EE, the object perception/traveling road perception block 10x, the action plan/trajectory generation block 20x, and the position control/posture control block 30x.

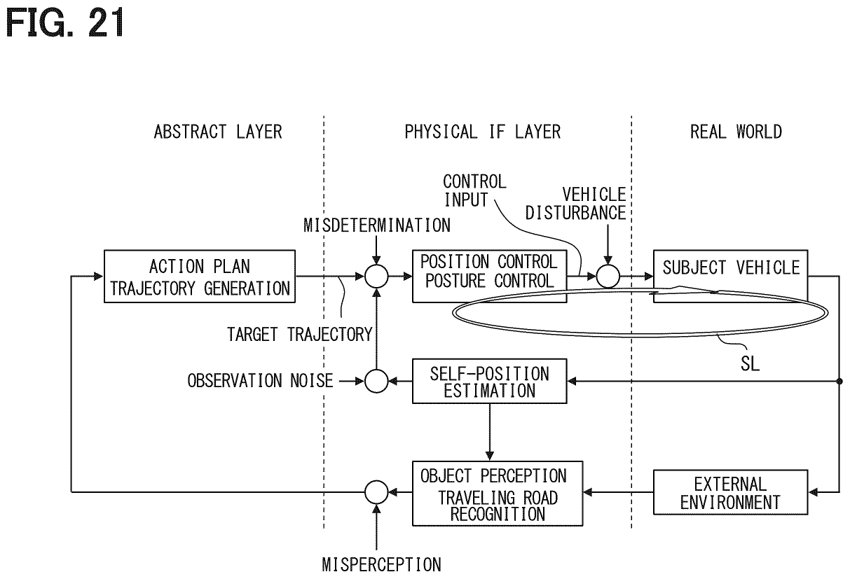

Furthermore, as shown in FIG. 21, in an actual vehicle, there is a closed loop (hereinafter referred to as vehicle body stabilization loop SL) that occurs between the body of the subject vehicle 1 or between the body of the subject vehicle 1 and the control unit 30. The vehicle body stabilization loop SL can be implemented by stabilizing the vehicle body by, for example, motor control in the power train, suspension control, or the like.

As shown in FIG. 18, various errors can be input in the causal loop. In the object perception/traveling road perception block 10x, an error classified as misperception may occur. In the self-position estimation block 10y, an error classified as observation noise may occur. In the action plan/trajectory generation block 20x, an error classified as misdetermination may occur. In the position control/posture control block 30x, an error classified as a vehicle disturbance may occur. The misperception and observation noise may be replaced with the above-described perception disturbance. The misdetermination may be replaced with the above-described traffic disturbance.

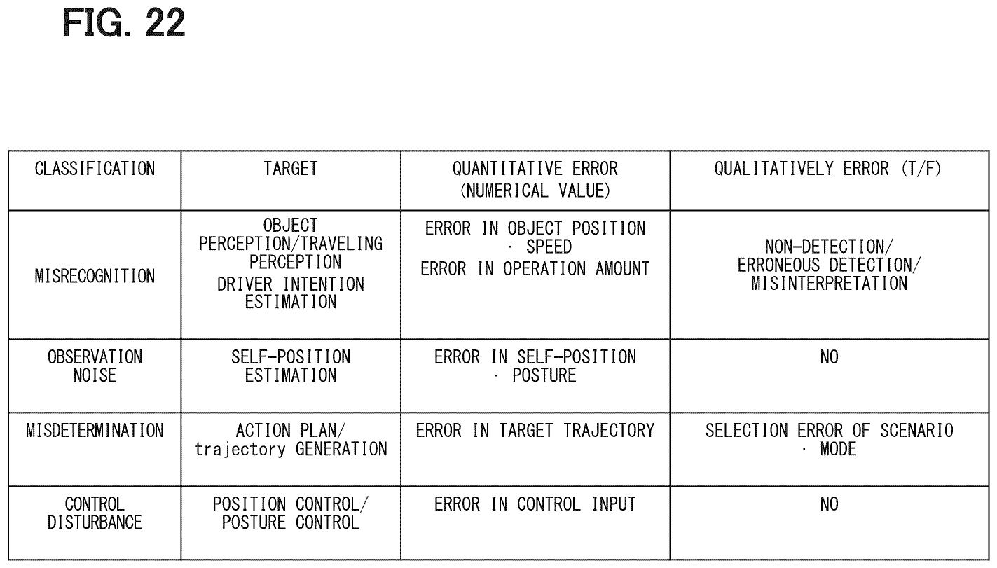

As shown in FIG. 22, targets of the misperception are, for example, object perception and traveling road perception. Quantitative errors in misperception are, for example, an error in object position and an error in speed. Qualitative errors in misperception are, for example, non-detection, erroneous detection, and misinterpretation. The target of observation noise is, for example, self-position estimation. Quantitative errors in observation noise include, for example, an error in self-position and an error in posture.

The targets of misdetermination are action planning and trajectory generation. A quantitative error in misdetermination is, for example, an error in the target trajectory. A qualitative errors in misdetermination are, for example, a scenario selection error and a mode selection error.

The targets of vehicle disturbance are position control and posture control. A quantitative error in a vehicle disturbance is, for example, an error in control input.

The quantitative errors can be directly expressed as errors using numerical values corresponding to physical quantities. Furthermore, the quantitative errors can be evaluated by a probability that the error falls within allowable error. The probability herein corresponds to the reliability.

On the other hand, the qualitative errors can be expressed as errors by discrete values such as true or false (T/F) or 1 or 0. By statistically collecting and processing each event, as a result, the error expressed in this way directly means the reliability. The qualitative errors in observation noise and qualitative errors in vehicle disturbance do not need to be taken into consideration. When an unknown qualitative error is found, the error can be evaluated using the reliability in the same way as other qualitative errors.

On the premise that each subsystem can be linearized, sensitivity to various errors is considered using a sensitivity function and a complementary sensitivity function. For example, as shown in FIG. 18, the transfer function from the target value to the output in each block using the causal loop is defined as P in the subject vehicle 1, E in the external environment EE, L in the self-position estimation block 10y, S in the object perception/traveling road perception block 10x, D in the action plan/trajectory generation block 20x, and K in the position control/posture control block 30x.

In the following, an error is used to mean a value obtained by quantifying a mistake, and deviation is used to mean a difference between the target value and the output value that appears in the driving system 2 due to the error.

However, when there is no distinction between the error and the deviation in the context, the error may indicate a concept including a value obtained by quantifying the error and a difference between the target value and the output value which appear in the driving system 2 by the value obtained by quantifying the error.

Assuming that the error due to vehicle disturbance is defined as d, the deviation from the target value due to the error can be expressed as shown in Equation 1 below.

$$e = \frac{( DSE - L ) P}{1 - ( DSE - L ) PK} d \qquad [ Equation 1 ]$$

The vehicle disturbance is mainly dealt with by the control unit 30 of the perception unit 10, the determination unit 20 and the control unit 30 based on the vehicle body stabilization loop SL. Therefore, the deviation due to the vehicle disturbance substantially affects the nominal performance of the control unit 30 rather than the robust performance of the driving system 2.

Assuming that the error due to misperception is defined as m, the deviation from the target value due to the error can be expressed as shown in Equation 2 below.

$$e = \frac{D}{1 - ( D S E - L ) P K} m \qquad [ Equation 2 ]$$

Assuming that the error due to observation noise is defined as n, the deviation from the target value due to the error can be expressed as shown in Equation 3 below.

$$e = \frac{1}{1 - ( D S E - L ) P K} n \qquad [ Equation 3 ]$$

Assuming that the error due to misdetermination is defined as j, the deviation from the target value due to the error can be expressed as shown in Equation 4 below.

$$e = \frac{1}{1 - ( D S E - L ) P K} j \qquad [ Equation 4 ]$$

The deviations due to misperception, observation noise, and misdetermination can propagate from the subsystem of a source to the other subsystem through the causal loop. Therefore, the deviations due to misperception, observation noise, and misdetermination affect the robust performance of the driving system 2.

The transfer function E of the external environment EE may be set based on a combination with the transfer function D of the action plan. For example, in the above-described traffic disturbance scenario, the functionalization of an interaction between the action or reaction of the subject vehicle 1 and an external factor of another road user or the like may be substantially equivalent to the setting of the transfer function E of the external environment EE.

The transfer function E of the external environment EE may be set in accordance with the premise that the external factor of another road user or the like follows, for example, a safety-related model and performs the action or reaction based on a reasonably foreseeable assumption.

On the other hand, the transfer function E of the external environment EE and the transfer function D of the action plan may be set as separate and independent functions.

There are errors that may occur in each subsystem due to specification or technology. When an allowable deviation e_max for the entire driving system 2 is determined, the allocation is adjusted again such that the errors d, m, n, and j do not exceed maximum allowable errors d_max, m_max, n_max, and j_max calculated by Equations 1 to 4 from the deviations allocated to the each of the subsystems. Therefore, the second design method based on the allocation of errors can be said to be a bottom-up design method in which the specification of the entire driving system 2 is adjusted after the specification of each subsystem is specified.

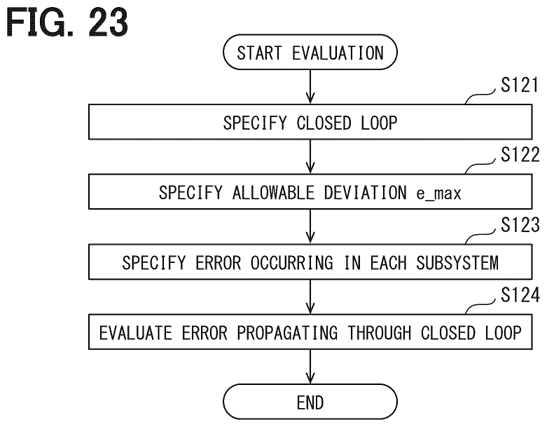

An example of the evaluation method used in the first design method will be described using the flowchart of FIG. 23. The implementing entity in each step of S121 to S124 is at least one of, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, a testing organization or authentication organization for the driving system 2, or the like. When the evaluation is performed by simulation, the actual implementing entity may be an evaluation device 81 or a design device 82 as shown in FIG. 15, for example. In each step of S121 to S124, the implementing entity may be a common entity or a different entity.

In S121, the interaction between each subsystem and the real world is modeled as a loop structure using the method similar to S101. Accordingly, at least one closed loop is specified. After S121, the process proceeds to S122.

In S122, the allowable deviation e_max for the entire driving system is specified. After S122, the process proceeds to S123.

In S123, an error occurring in each subsystem is specified. The specification method of an error herein differs depending on the intention and purpose of the evaluation. For example, when it is desired to evaluate a deviation occurring in the driving system 2 based on the current subsystem specification or performance, the error is set based on the current subsystem specification or performance.

In S124, the closed loop specified in S121 is evaluated based on the allowable deviation e_max specified in S122. When multiple closed loops are specified, evaluation may be performed on all of the closed loops. On the other hand, some closed loop evaluations that have a little degree of influence as composite factors may be omitted. The series of evaluations ends at S124. The order of S121 to S123 can be changed as appropriate, and S121 to S123 can be performed simultaneously.

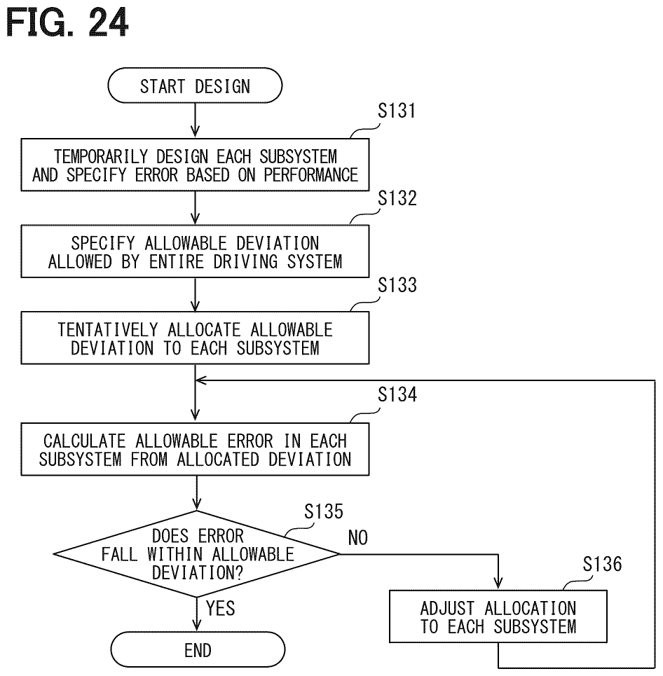

Next, an example of the second design method will be described using the flowchart of FIG. 24. The implementing entity in each step of S131 to S136 may be, for example, the vehicle manufacturer, the vehicle designer, the manufacturer of the driving system 2, the designer of the driving system 2, the manufacturer of the subsystems constituting the driving system 2, the designer of the subsystem, a person commissioned by the manufacturer or designer thereof, or the like. The actual implementing entity may be the design device 82. In each step of S131 to S136, the implementing entity may be a common entity or a different entity.

In S131, each subsystem is temporarily designed. In each temporarily designed subsystem, an error based on the performance thereof is specified. After S131, the process proceeds to S132.

In S132, the allowable deviation allowed by the entire driving system 2 is specified. This allowable deviation may be determined based on the specification of the entire driving system 2. For example, the allowable deviation may be determined by back-calculating a safe margin from a positive risk balance. After S132, the process proceeds to S133.

In S133, an allowable deviation is tentatively allocated to each subsystem based on the allowable deviation of the entire driving system 2. In this case, the tentative allocation may be equal allocation to each subsystem. The equal allocation is an allocation in which the perception system 10a takes in charge or substantially 1/3(33%) of the allowable deviation of the entire driving system 2, the determination system 20a takes in charge of substantially 1/3 (33%) of the allowable deviation of the entire driving system 2, and the control system 30a takes in charge of substantially 1/3(33%) of the allowable deviation of the entire driving system 2. As illustrated in FIG. 17, when it is considered that the perception system 10a is divided into the object perception/traveling road perception block 10x and the self-position estimation block 10y, the deviation taken in charge by the perception system 10a may be further divided into the object perception/traveling road perception block 10x and the self-position estimation block 10y.

When an empirically certain appropriate allocation is found, the empirically obtained allocation may be tentatively used. After S133, the process proceeds to S134.

In S134, Equations 1 to 4, which are obtained by mathematizing the error propagating through the closed loop, are back-calculated, so that maximum allowable errors d_max, m_max, n_max, and j_max required for each subsystem can be calculated from the deviation allowed to each subsystem. After S134, the process proceeds to S135.

In S135, it is determined for each subsystem whether the errors d, m, n, and j of each subsystem specified in S131 fall within the maximum allowable errors d_max, m_max, n_max, and j_max that are tentatively allocated to the subsystems. When an affirmative determination is made for all subsystems, the allocation of allowable error to each system is determined, and the series of processes is completed. When a negative determination is made for at least one subsystem, the process proceeds to S136.

In S136, the allocation to each subsystem is adjusted. That is, adjustment is performed in S135 such that the allocation to the subsystem whose error exceeds the allowable error is increased, and the allocation to the subsystem whose error falls within the allowable error is decreased.

For example, a case in which a tentatively equal allocation is made to each subsystem in S132 is considered. In S135, it is determined that the error of the perception system 10a falls within the allowable error that is tentatively allocated to the perception system 10a, and it is determined that the error of the control system 30a falls within the allowable error that is tentatively allocated to the control system 30a. On the other hand, it is determined in S135 that the error of the determination system 20a exceeds the allowable error that is tentatively allocated to the determination system 20a. In this case, adjustments may be performed such as decreasing the allocation to the perception system 10a to, for example, 20%, increasing the allocation to the determination system 20a to, for example, 60%, and decreasing the allocation to the control system 30a, for example, to 20%. After S136, the process returns to S134.

By repeating the adjustment in S134 to S136, when an allocation solution is found in which the errors d, m, n, and j occurring in all subsystems fall within the allowable errors d_max, m_max, n_max, and j_max, the allocation of the allowable error of each subsystem can be determined at that time. On the other hand, when the allocation solution is not found in which the errors d, m, n, and j occurring in all subsystems fall within the allowable errors d_max, m_max, n_max, and j_max, the specification of at least one subsystem needs to be reviewed. In other words, it is necessary to improve the performance of the subsystem such that the occurring errors is reduced.

The first design method and the second design method may be implemented selectively. On the other hand, when the first design method and the second design method are implemented in combination, it is possible to design the driving system 2 with higher validity. For example, after the allocation of the allowable error is performed using the second design method, the allocation of reliability is performed using the first design method, so that the driving system 2 optimized by both the allowable error and the reliability may be designed. For example, after the allocation of reliability is performed using the first design method, the allocation of the allowable error is performed using the second design method, so that the driving system 2 optimized by both the allowable error and the reliability may be designed.

### <Driving System Implemented by Evaluating Composite Factor>

The driving system 2 designed by the design method described above, particularly, the driving system 2 that performs a processing method using the allocated reliability will be described.

The driving system 2 stores an allocation of dynamic reliability for each allocation category that are determined during the design. One or more storage media (for example, non-transitory tangible storage media) storing the allocation of reliability may be provided. The storage medium may be the memory 51a included in the dedicated computer 51 of the processing system 50, the scenario DB 53, or the memory 55a of the recording device 55.

The driving system 2 refers to the allocation of reliability for each allocation category and changes a condition for executing the driving dynamic task. The allocation category is set based on the type of ODD use case, scenario, and the like, for example. In other words, while the subject vehicle 1 is traveling, the allocation of reliability in the driving system 2 substantially changes dynamically depending on the current situation of the subject vehicle 1.

For example, the driving system 2 may determine which component of the driving system 2 is to be used as a main component to implement the dynamic driving task in accordance with the ODD, the scenario, and the like. That is, the driving system 2 may flexibly switch a combination of main components in order to implement the dynamic driving task in accordance with the ODD, the scenario, and the like. Some of the sensors 40 may be selected as the main components from among multiple sensors 40 that implement the perception system 10a. The combination herein includes, for example, a combination of a camera, a map and control, a combination of a millimeter wave radar, a map and control, a combination of a camera, a millimeter wave radar and control, and the like.

For example, the driving system 2 may determine whether to plan a careful control action based on a product value of the reliability of the perception system 10a and the reliability of the control system 30a for the reliability allocated in accordance with the ODD, the scenario, and the like. The driving system 2 may determine to plan a careful control action when the product value becomes smaller than a preset set value. This set value may be set according to at least one of the stable controllable range R1 and the performance limit range R2.

The conditions for performing the dynamic driving task may include conditions for the environment determination unit 21 to determine the environment. The environment determination unit 21 selects a scenario and refers to the allocation of reliability corresponding to the scenario. The environment determination unit 21 may interpret the environment model in consideration of the reliability. For example, when the communication disturbance scenario is selected, in order to interpret the environment model that achieves the reliability allocated to the perception system 10a corresponding to the scenario, the environment determination unit 21 may ensure the reliability of the entire perception system 10a by interpreting the environment model in the premise of reducing contribution of information acquired by the map and V2X.

The condition for executing the dynamic driving task may include a condition for the driving planning unit 22 to determine a behavior plan and a trajectory plan. The driving planning unit 22 may determine the behavior plan and the trajectory plan in consideration of the allocation of reliability according to the scenario selected by the environment determination unit 21. For example, when the determination system 20a is required to have high reliability due to the low reliability of the perception system 10a and the low reliability of the control system 30a, the driving planning unit 22 may plan more careful control action than an ordinary plan. The careful control action may include transition to degeneracy action, execution of MRM, transition to DDT fallback, or the like.

The condition for executing the dynamic driving task may include a condition for determining at least one of a mode managed by the mode management unit 23 and a constraint to be set. The mode management unit 23 may set functional constraints in consideration of the allocation of reliability in accordance with the scenario selected by the environment determination unit 21. For example, when the determination system 20a is required to have high reliability due to the low reliability of the perception system 10a and the low reliability of the control system 30a, the mode management unit 23 may set constraints such as an upper limit of speed and an upper limit of acceleration in the behavior plan and the trajectory plan planned by the driving planning unit 22.

The condition for executing a dynamic driving task may be a condition such as a triggering condition, a minimal risk condition, a fallback condition, and the like. In addition, a change in condition for executing the dynamic driving task may be a change in the conditional equation itself or a change in numerical value input to the conditional equation.

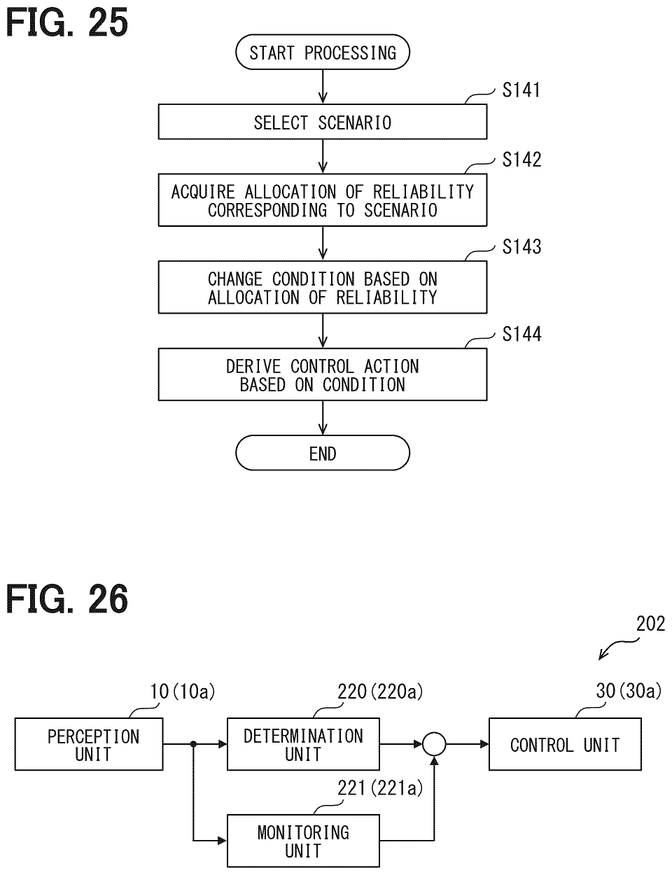

Hereinafter, an example of processing related to the change in condition for implementing the dynamic driving task will be described in the operation flow of the driving system 2 using the flowchart in FIG. 25. The series of processes shown in steps S141 to S144 is repeatedly executed by the driving system 2 at predetermined time intervals or based on a predetermined trigger.

In S141, the environment determination unit 21 selects a scenario based on a situation in which the subject vehicle 1 is currently placed. After S141, the process proceeds to S142.

In S142, at least one execution entity among the environment determination unit 21, the driving planning unit 22, and the mode management unit 23 acquires a scenario selected in S141, and acquires an allocation of reliability corresponding to the scenario from the storage medium in which the allocation of reliability is stored. After processing S142, the process proceeds to S143.

In S143, the execution entity in S142 changes the condition for implementing the dynamic driving task based on the acquired allocation of reliability. After processing S143, the process proceeds to S144.

In S144, the driving planning unit 22 derives a control action based on the condition or the result of executing calculation processing according to the condition. The series of processes ends at S144.

The scenario used in the processing of S141 to S144 may be replaced with ODD, or may be replaced with a combination of scenario and ODD.

### <Operation And Effects>

The operation and effects of the first embodiment described above will be described below.

According to the first embodiment, the allocation of the allowable error to each subsystem is adjusted. In such adjustment, comparison between an error occurring in each of temporarily designed subsystems and the allowable error is used. The allowable error is specified by evaluating the deviation of the allowable error of the entire driving system 2 that is tentatively allocated to each subsystem and the error propagating through the driving system 2. As a result of the evaluation of the error propagating through the driving system 2, a composite factor based on the interaction between each of the subsystems can be reflected in the design. Therefore, the validity of the driving system 2 including multiple subsystems can be enhanced.

According to the first embodiment, the specification of each of the subsystems is determined such that the error propagating through the driving system 2 will fall within the allowable error with a probability greater than or equal to a predetermined reliability. That is, the reliability is introduced as a common measure by applying evaluation based on probability theory to each of the subsystems. Therefore, even when the perception system 10a, the determination system 20a, and the control system 30a each have different functions, the composite factor caused by the interaction therebetween can be appropriately reflected in the design. Therefore, the validity of the driving system 2 including multiple subsystems can be enhanced. Furthermore, a system configuration for enhancing continuity of the operation of the driving system 2 can be easily implemented by mutual complementation of each subsystem.

According to the first embodiment, the error propagating through the driving system 2 is evaluated according to the closed loop in which the interaction between each subsystem and the real world is modeled as a loop structure. Through the closed loop, the error occurring in each subsystem can be represented in the form that can simulate the propagation between each of the subsystems, so that the composite factor of each of the subsystems can be easily confirmed. Therefore, the validity of the driving system 2 including multiple subsystems can be appropriately confirmed.

According to the first embodiment, the closed loop includes the inner loop IL that circulates through the subject vehicle 1 in the real world, the perception system 10a, and the control system 30a and is completed in the subject vehicle 1. The inner loop IL is evaluated, so that the propagation of the error that has not been detected only by the evaluation related to the determination system 20a can be confirmed.

According to the first embodiment, the closed loop includes the outer loop EL that circulates through the subject vehicle 1 in the real world, the external environment EE in the real world, the perception system 10a, the determination system 20a, and the control system 30a, and that evaluates the interaction between the subject vehicle 1 and the external environment EE. The outer loop EL is evaluated so that a composite factor of the perception system 10a, the determination system 20a, and the control system 30a can be appropriately confirmed.

According to the first embodiment, the condition for implementing the dynamic driving task is changed based on the allocation of reliability to each subsystem stored in storage media such as the memory 51a, the scenario DB 53, and the memory 55a. That is, since the reliability, which is a common measure between each of the subsystems, is used, even when the perception system 10a, the determination system 20a, and the control system 30a each have different functions, it is possible to change the conditions in consideration of a load applied to each of the subsystems, which may vary depending on an allocation category. Therefore, the high validity can be implemented in the driving system 2 including multiple subsystems.

According to the first embodiment, the scenario in which the subject vehicle 1 is currently placed is selected. Furthermore, in changing the condition for implementing the dynamic driving task, it is determined whether to transition to the degeneracy action based on the product value of the reliability of the perception system 10a and the reliability of the control system 30a by referring to the allocation of reliability determined corresponding to the scenario. Therefore, even when the reliability of one of the perception system 10a and the control system 30a is low, when the reliability of the other is high, it is possible to avoid the transition to the degeneracy action and to appropriate continue the driving action. Therefore, a highly flexible response can be implemented in the driving system 2.

According to the first embodiment, the interaction between each subsystem and the real world is modeled as a loop structure. Through the specified closed loop, the error occurring in each subsystem can be represented in the form that can simulate the propagation between each of the subsystems. The error propagating in accordance with the closed loop is evaluated, so that the composite factor of each of the subsystems can be confirmed. Therefore, the validity of the driving system 2 including multiple subsystems can be appropriately confirmed.

According to the first embodiment, the interaction between each subsystem and the real world is modeled as a loop structure. The evaluation of the specified closed loop is based on the reliability, which is a common measure between each of the subsystems. By introducing reliability as a common measure, even when the perception system 10a, determination system 20a, and control system 30a each have different functions, it is possible to confirm the composite factors caused by their interactions. Therefore, the validity of the driving system 2 including multiple subsystems can be appropriately confirmed.

Further, according to the first embodiment, it is evaluated that the error propagating in accordance with the closed loop falls within the allowable error with a probability greater than or equal to a predetermined reliability. By applying evaluation based on probability theory to each subsystem, the validity of the driving system 2 can be appropriately confirmed. Furthermore, a system configuration for enhancing continuity of the operation of the driving system 2 can be easily implemented by mutual complementation of each subsystem.

According to the first embodiment, the closed loop includes the inner loop IL that circulates through the subject vehicle 1 in the real world, the perception system 10a, and the control system 30a and is completed in the subject vehicle 1. The inner loop IL is evaluated, so that the propagation of the error that has not been detected only by the evaluation related to the determination system 20a can be confirmed.

According to the first embodiment, the closed loop includes the outer loop EL that circulates through the subject vehicle 1 in the real world, the external environment EE in the real world, the perception system 10a, the determination system 20a, and the control system 30a, and that evaluates the interaction between the subject vehicle 1 and the external environment EE. The outer loop EL is evaluated so that a composite factor of the perception system 10a, the determination system 20a, and the control system 30a can be appropriately confirmed.

### Second Embodiment

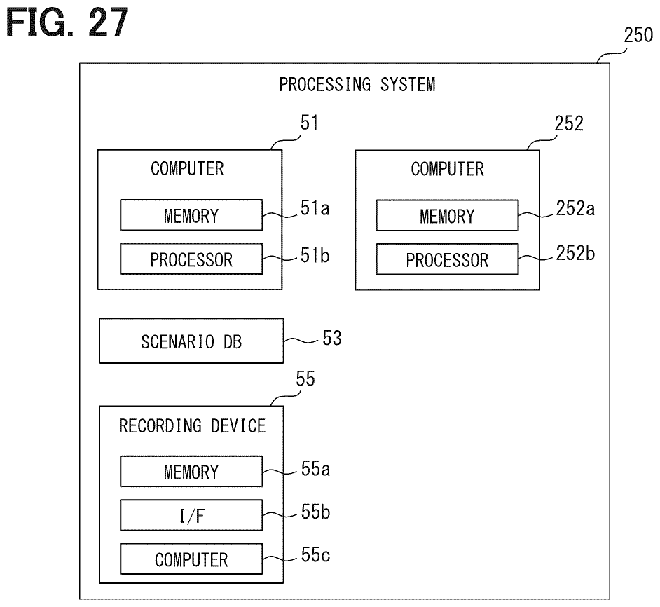

As shown in FIGS. 26 and 27, a second embodiment is a modification of the first embodiment. The second embodiment will be described focusing on matters different from the first embodiment.

As shown in FIG. 26, a driving system 202 of the second embodiment may further include a monitoring unit 221 that monitors a determination unit 220 at a functional level. In other words, a monitoring system 221a may be provided as a subsystem that monitors a determination system 220a. On the other hand, the monitoring unit 221 or the monitoring system 221a may be positioned as a part of the determination unit 220 or the determination system 220a, which is included in the determination unit 220 or the determination system 220a.

As shown in FIG. 27, the driving system 202 further includes a dedicated computer 252 for implementing a monitoring function at a technical level. The dedicated computer 252 may be provided on the same substrate as a dedicated computer 51 in a processing system 250 that implements a determination function, and may enable communication with each other on-board. On the other hand, the dedicated computer 252 may be implemented in the form of a monitoring ECU provided separately from the processing system 250 that implements the determination function. The dedicated computer 252 may be, for example, an RSS system that implements a safety-related model such as an RSS model.

The dedicated computer 252 has at least one memory 252a and at least one processor 252b. The memory 252a may be at least one type of non-transitory tangible storage medium, such as a semiconductor memory, a magnetic medium, an optical medium, and the like, which non-temporarily stores a program, data, and the like that can be read by the processor 252b. Furthermore, a rewritable volatile storage medium such as a random access memory (RAM) may be provided as the memory 252a. The processor 252b includes, as a core, at least one type of, for example, a central processing unit (CPU), a graphics processing unit (GPU), and a reduced instruction set computer (RISC)-CPU.

The dedicated computer 252 may be a system on a chip (SoC) that is implemented by integrating the memory, the processor, and the interface as one chip, and may have an SoC as a component of the dedicated computer.

The monitoring unit 221 acquires information such as an environment model and a vehicle state from a perception unit 10, and monitors at least one of a risk occurring between a subject vehicle 1 and another road user and a risk caused by misdetermination of the determination unit 220. The monitoring unit 221 sets, for example, a safety envelope. The monitoring unit 221 detects a violation of the safety envelope in at least one of control actions derived by the subject vehicle 1 and the determination unit 220.

The safety envelope may be set according to assumptions based on safety-related models. The assumptions based on safety-related models may be reasonably foreseeable assumptions about another road user. The assumptions are, for example, assumptions of a reasonable worst case of another road user in the RSS model, in which the minimum safe distance in the longitudinal direction and the minimum safe distance in the lateral direction may be calculated. The assumptions may be set based on the scenario selected by the perception unit 10, the determination unit 220, or the monitoring unit 221. The safety envelope may define a boundary around the subject vehicle 1. The safety envelope may be set based on the kinematic characteristics of another road user, traffic rules, region, and the like.

The monitoring unit 221 may change the control action derived by the determination unit 220 when the violation of the safety envelope is detected. The change in control action herein may correspond to a proper response, a transition to the minimal risk condition, or DDT fallback.

The monitoring unit 221 may reject the control action derived by the determination unit 220 when the violation of the safety envelope is detected. In this case, the monitoring unit 221 may set constraints on the determination unit 220. When the control action is rejected, the determination unit 220 may derive the control action again based on the set constraints.

The safety-related model or mathematical model used for monitoring by the monitoring unit 221 may be able to invalidate quantitative errors and qualitative errors caused by misdetermination in the determination unit 220. The safety-related model or mathematical model may be able to forcibly correct errors due to quantitative errors and qualitative errors caused by misdetermination in the determination unit 220 to within an allowable range.

That is, by mounting the monitoring unit 221, the error j due to the misdetermination can be regarded as substantially zero. On the other hand, the error d due to vehicle disturbance, the error m due to misperception, and the error n due to observation noise remain, and these errors propagate in accordance with the closed loop.

Therefore, even in the driving system 202 including the monitoring function of the monitoring unit 221, the verification and validation of the composite factor of the subsystems is effective. The evaluation method and design method of the first embodiment may also be applied to the driving system 202. Similar to the first embodiment, the determination unit 220 or the monitoring unit 221 can also change the condition for implementing the dynamic driving task based on the allocation of reliability.

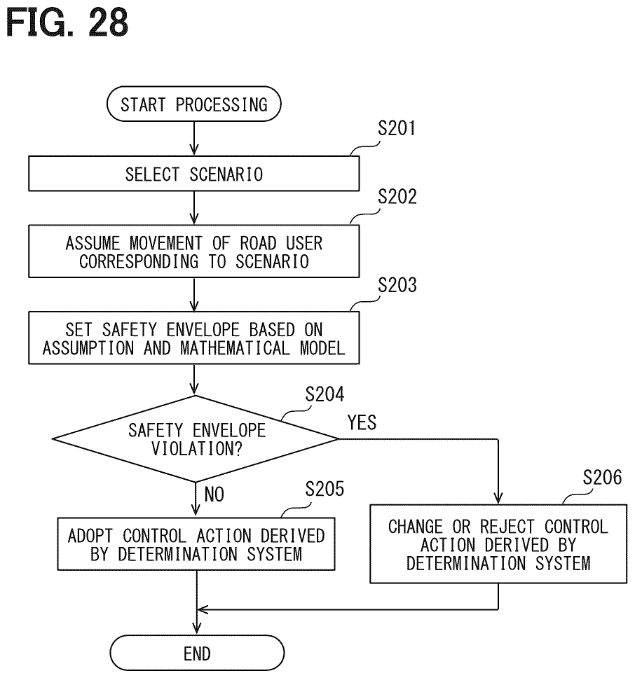

Hereinafter, an example of processing related to the monitoring function by the monitoring system 221a will be described in the operation flow of the driving system 202 using the flowchart in FIG. 28. The series of processes shown in steps S201 to S206 is repeatedly executed by the driving system 202 at predetermined time intervals or based on a predetermined trigger.

In S201, the scenario in which the subject vehicle 1 is currently placed is selected. After S201, the process proceeds to S202.

In S202, a movement of another road user is assumed within a reasonable and predictable range based on the scenario selected in S201. After S202, the process proceeds to S203.

In S203, a safety envelope is set based on the assumptions and mathematical model in S202. The mathematical model herein Is a mathematical model that invalidates a quantitative error and qualitative error of the misdetermination in the determination function, and a mathematical model that forcibly corrects the error caused by the quantitative error and qualitative error of misdetermination in the determination function within an allowable range. After processing S203, the process proceeds to S204.

In S204, a violation of the safety envelope is detected using information such as the environment model. That is, it is determined whether the violation has occurred. When a negative determination is made in S204, the process proceeds to S205. When an affirmative determination is made in S205, the process proceeds to S206.

In S205, the control action derived by the determination function is adopted. The series of processes ends at S205.

In S206, the control action derived by the determination function is changed or rejected. The series of processes ends at S206.

### Third Embodiment

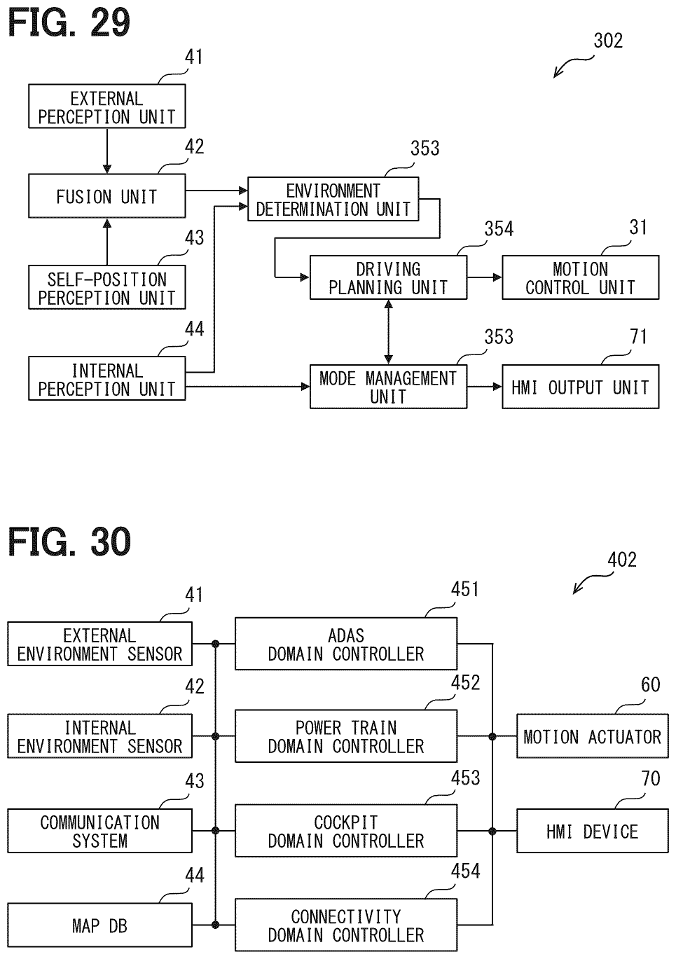

As shown in FIG. 29, a third embodiment is a modification of the first embodiment. The second embodiment will be described focusing on matters different from the first embodiment.

In a driving system 302 of the third embodiment, direct input/output of information is not performed between a perception unit 10 and a control unit 30. That is, the information output by the perception unit 10 is input to the control unit 30 through a determination unit 20. For example, at least one of the vehicle state recognized by an internal perception unit 14, such as the current speed, acceleration, and yaw rate of a subject vehicle 1, is delivered to a motion control unit 31 as it is through an environment determination unit 321 and a driving planning unit 322, or through a mode management unit 323 and the driving planning unit 322.

That is, the environment determination unit 321 and the driving planning unit 322 or the mode management unit 323 and the driving planning unit 322 have a function of processing some of types of information acquired from the internal perception unit 14 to output the information to the motion control unit 31 in the form such as a trajectory plan, and outputting some of types of the other information acquired from the internal perception unit 14 to the motion control unit 31 as raw information.

Therefore, the interaction between the perception unit 10 and the control unit 30 in the physical IF layer of the causal loop shown in FIG. 5 is substantially implemented.

### Fourth Embodiment

As shown in FIG. 30, a fourth embodiment is a modification of the first embodiment. The second embodiment will be described focusing on matters different from the first embodiment.

A driving system 402 of the fourth embodiment has a configuration in which a domain-type architecture that implements driving support up to Level 2 is adopted. An example of a detailed configuration of the driving system 402 at a technical level will be described with reference to FIG. 30.

As in the first embodiment, the driving system 402 includes multiple sensors 41 and 42, multiple motion actuators 60, multiple HMI devices 70, multiple processing systems, and the like. Each processing system is a domain controller that aggregates processing functions for each functional domain. The domain controller may have the same configuration as the processing system or ECU of the first embodiment. For example, the driving system 402 includes an ADAS domain controller 451, a power train domain controller 452, a cockpit domain controller 453, a connectivity domain controller 454, and the like as processing systems.

The ADAS domain controller 451 aggregates functions related to advanced driver-assistance systems (ADAS). The ADAS domain controller 451 may implement a part of the perception function, a part of the determination function, and a part of the control function in a composite manner. A part of the perception function implemented by the ADAS domain controller 451 may be, for example, a function corresponding to the fusion unit 13 of the first embodiment, or a function simplified therefrom. A part of the determination function implemented by the ADAS domain controller 451 may be, for example, a function corresponding to the environment determination unit 21 and the driving planning unit 22 of the first embodiment, or a function simplified therefrom. A part of the control function implemented by the ADAS domain controller 451 may be, for example, a function of generating request information for the motion actuator 60 among the functions corresponding to the motion control unit 31 of the first embodiment.

Specifically, the functions implemented by the ADAS domain controller 451 are functions of supporting the traveling of the vehicle in a non-hazardous scenario such as a lane maintenance support function of allowing a subject vehicle 1 to travel along a lane line and a vehicle-to-vehicle distance maintenance function of following the leading other vehicle positioned in front of the subject vehicle 1 with a predetermined vehicle-to-vehicle distance therebetween. In addition, the functions implemented by the ADAS domain controller 451 are functions of implementing a proper response in the hazardous scenario such as a collision damage mitigation brake function of applying brakes in the case of a collision with another road user or obstacle, and an automatic steering avoidance function of using steering to avoid a collision when a collision with another road user or obstacle occurs.

The power train domain controller 452 aggregates functions related to control of a power train. The power train domain controller 452 may perform at least part of the perception function and at least part of the control function in a composite manner. A part of the perception function implemented by the power train domain controller 452 may be, for example, a function of recognizing an operation state of the driver for the motion actuator 60 among the functions corresponding to the internal perception unit 14 of the first embodiment. A part of the control function implemented by the power train domain controller 452 may be, for example, a function of controlling the motion actuator 60 among the functions corresponding to the motion control unit 31 of the first embodiment.

The cockpit domain controller 453 aggregates functions related to cockpit. The cockpit domain controller 453 may implement at least part of the perception function and at least part of the control function in a composite manner. A part of the perception function implemented by the cockpit domain controller 453 may be, for example, a function of recognizing a switch state of the HMI device 70 in the internal perception unit 14 of the first embodiment. A part of the control function implemented by the cockpit domain controller 453 may be, for example, a function corresponding to the HMI output unit 71 of the first embodiment.

The connectivity domain controller 454 aggregates functions related to connectivity. The connectivity domain controller 454 may implement at least a part of the perception function in a composite manner. A part of the perception function implemented by the connectivity domain controller 454 may be a function of organizing and converting global position data, V2X information, and the like of the subject vehicle 1 acquired from the communication system 43 in the form that can be used by the ADAS domain controller 451, for example.

Also in the fourth embodiment, the function of the driving system 402 including each of the domain controllers 451, 452, 453, and 454 can be associated with a perception unit 10, a determination unit 20, and a control unit 30 in the functional level. Therefore, it is possible to perform evaluation using the causal loop structure as in the first embodiment.

### Other Embodiments

Although multiple embodiments have been described above, the present disclosure is not construed as being limited to those embodiments, and can be applied to various embodiments and combinations within a scope that does not depart from the spirit of the present disclosure.

A driving system 2 is applicable to various moving objects other than vehicles. The moving object is, for example, a ship, an aircraft, a drone, a construction machine, an agricultural machine, or the like.

The control unit and the method thereof described in the present disclosure may be implemented by a dedicated computer constituting a processor programmed such that one or more functions embodied by a computer program is executed. Alternatively, the device and the method thereof according to the present disclosure may be implemented by a dedicated hardware logic circuit. Alternatively, the device and the method thereof according to the present disclosure may be implemented by one or more dedicated computers configured with a combination of a processor that executes a computer program and one or more hardware logic circuits. The computer program may be stored in a non-transitory tangible computer-readable recording medium as an instruction to be executed by a computer.

### Explanation of Terms

Terms related to the present disclosure are described below. This description is included in embodiments of the present disclosure.

The road user may be a person who uses the road, including sidewalks and other adjacent spaces. The road user may be a road user who is on or adjacent to an active road for the purpose of moving from one location to another.

The dynamic driving task (DDT) may be real-time operational and tactical functions for operating a vehicle in traffic.

The automated driving system may be hardware and software that are collectively capable of performing the entire DDT on a sustained basis, regardless of whether or not the autonomous driving system is limited to a specific operational design domain.

The safety of the intended functionality (SOTIF) may be the absence of unreasonable risks due to inadequacy of the intended functionality or its implementation.

The driving policy may be a strategy and a rule that define a control action at a vehicle level.

The vehicle motion may be a vehicle state and dynamics thereof in terms of physical quantities (for example, a speed and an acceleration).

The situation may be a factor that can affect the behavior of the system. The situation may include a traffic situation, weather, and behavior of the subject vehicle.

The estimation of the situation may be reconstruction of a parameter group representing the situation using an electron system from the situation obtained from the sensor.

The scenario may be description of a temporal relationship between several scenes, with goals and values within a specified situation in a sequence of scenes influenced by actions and events. The scenario may be description of consecutive time series of activities integrates the subject vehicle, all its external environment, and their interaction in the process of performing a certain driving task.

The behavior of the subject vehicle may be obtained by interpreting a vehicle motion based on traffic situations.

A triggering condition may be a specific condition of a scenario that serves as an initiator for a subsequent system reaction contributing to either a hazardous behavior and reasonably foreseeable indirect misuse, which is a subsequent reaction of the system.

The proper response may be an action for remediation of hazardous situation when other road users act in accordance with an assumption about reasonably foreseeable behaviors.

The hazardous situation may be a scenario that represents an increased level of risk that exists in DDT unless preventive action is taken.

The safe situation may be a situation in which the system is within the performance limit that ensures safety. It should be noted that the safe situation becomes a design concept depending on the definition of performance limit.

The minimal risk maneuver (MRM) may be (automated) driving system's capability of transitioning the vehicle between nominal and minimal risk conditions.

The DDT fallback may be a response by the driver or automation system to either perform the DDT or transition to a minimal risk condition after the occurrence of a failure(s) or detection of a functional insufficiency or upon detection of a potentially hazardous behavior.

The performance limit may be a design limit at which a system can achieve the purpose thereof. The performance limit can be set for multiple parameters.

The operational design domain (ODD) may be a specific condition which is designed such that a given (automated) driving system functions. The operational design domain is an operating conditions under which a given (automated) driving system or feature thereof is specifically designed to function, including, but not limited to, environmental, geographical, and time-of-day restrictions, and/or the requisite presence of certain traffic or roadway characteristics.

The (stable) controllable range may be a range of design values that allow the system to continue the purpose thereof. The (stable) controllable range can be set for multiple parameters.

The minimal risk condition may be a condition of the vehicle to reduce a risk in a case of not being able to complete a given trip. The minimal risk condition may be a condition to which a user or an automated driving system may bring a vehicle after performing the MRM in order to reduce the risk of a crash when a given trip cannot be completed.

The takeover may be transfer of the driving task between the automated driving system and the driver.

The unreasonable risk may be a risk that is determined to be unacceptable in a particular situation according to valid social moral concepts.

The safety-related model may be representation of a safety-related aspect of the driving action based on assumptions on the reasonably foreseeable behavior of another road user. The safety-related model may be an on-board or off-board safety verification device or safety analysis device, a mathematical model, a set of more conceptual rules, a set of scenario-based behaviors, or a combination thereof.

The safety envelope may be a set of limits and conditions, within which the system is designed to operate, subject to constraints or controls, in order to maintain operations within a level of acceptable risk. The safety envelope may be a general concept that can be used to comply with all principles that a driving policy can comply with, and according to this concept, a subject vehicle operated by the (automated) driving system can have one or more boundaries therearound.

### Appendix

The present disclosure also includes the following technical features based on the above embodiments.

### <Technical Feature 1>

An evaluation method of a driving system of a moving object, which includes a perception system, a determination system, and a control system as subsystems, including:
evaluating a nominal performance of the perception system;
evaluating a nominal performance of the determination system; and
evaluating a nominal performance of the control system.

### <Technical Feature 2>

An evaluation method of a driving system of a moving object, which includes a perception system, a determination system, and a control system as subsystems, including:
evaluating a nominal performance of the determination system; and
evaluating a robust performance of the determination system in consideration of at least one of an error of the perception system and an error of the control system.

### <Technical Feature 3>

An evaluation method of a driving system of a moving object, which includes a perception system, a determination system, and a control system as subsystems, including:
independently evaluating each of a nominal performance of the perception system, a nominal performance of the determination system, and a nominal performance of the control system; and
evaluating a robust performance of an entire driving system such that a composite factor of the perception system and the determination system, a composite factor of the determination system and the control system, and a composite factor of the perception system and the control system are included in an evaluation target.

### <Technical Feature 4>

A driving system of a moving object, which includes a perception system, a determination system, and a control system as subsystems, in which the driving system includes:
a first closed loop which is a loop indicating an interaction between each subsystem and a real world, circulates through the moving object in the real world, the perception system, and the control system, and is completed in the moving object; and
a second closed loop which is a loop indicating an interaction between each subsystem and the real world, circulates through the moving object in the real world, an external environment in the real world, the perception system, the determination system, and the control system, and includes an interaction between the moving object and the external environment, and
the driving system is configured such that an error propagating through the first closed loop and the second closed loop falls within a predetermined allowable error.

### <Technical Feature 5>

A driving system of a moving object, which includes a perception system, a determination system, and a control system as subsystems, in which the driving system includes:
a first closed loop which is a loop indicating an interaction between each subsystem and a real world, circulates through the moving object in the real world, the perception system, and the control system, and is completed in the moving object; and
a second closed loop which is a loop indicating an interaction between each subsystem and the real world, circulates through the moving object in the real world, an external environment in the real world, the perception system, the determination system, and the control system, and includes an interaction between the moving object and the external environment, and
the driving system is configured such that an error propagating through the first closed loop and the second closed loop falls within a predetermined allowable error at a probability of a predetermined reliability or greater.

### <Technical Feature 6>

A monitoring system that includes at least one processor and monitors a determination function in driving of a moving object,
in which the processor is configured to execute:
detecting a violation of a safety envelope based on a mathematical model that invalidates a quantitative error and a qualitative error of misdetermination in a determination function; and
changing or rejecting a control action derived by the determination function when the violation of the safety envelope is detected.

### <Technical Feature 7>

A monitoring system that includes at least one processor and monitors a determination function in driving of a moving object,
in which the processor is configured to execute:
detecting a violation of a safety envelope based on a mathematical model that forcibly corrects an error caused by a quantitative error and a qualitative error of misdetermination in a determination function within an allowable range; and
changing or rejecting a control action derived by the determination function when the violation of the safety envelope is detected.

1. A design method of a driving system, which includes a plurality of subsystems and implements a dynamic driving task of a moving object in cooperation with each of the subsystems, the design method, which is performed by at least one processor, comprising:
calculating an error occurring in each of temporarily designed subsystems;
tentatively allocating, to each of the subsystems, an allowable deviation that is allowed for an entire driving system;
specifying an allowable error, which is allowed for each of the subsystems, from a deviation allocated to each of the subsystems based on an evaluation on an error propagating through the driving system; and
adjusting allocation of the allowable error to each of the subsystems based on a result of comparing the calculated error with an allowable error of the subsystem corresponding to the calculated error.

2. A design method of a driving system, which includes a plurality of subsystems and implements a dynamic driving task of a moving object in cooperation with each of the subsystems, the design method, which is performed by at least one processor, comprising:
introducing reliability into each of the subsystems as a common measure between each of the subsystems to evaluate a composite factor between the subsystems;
allocating the reliability to each of subsystems based on a specification of the driving system; and
determining the specification of each of the subsystems such that an error, which is generated in each of the subsystems and propagates through the driving system, falls within an allowable error with a probability of a predetermined reliability or higher.

3. The design method according to claim 1, wherein
the error propagating through the driving system is evaluated according to a closed loop in which an interaction between each of the subsystems and a real world is modeled as a loop structure.

4. The design method according to claim 3, wherein
the plurality of subsystems includes a perception system, a determination system, and a control system.

5. The design method according to claim 4, wherein
the closed loop includes a loop that circulates through the moving object in the real world, the perception system, and the control system, and
the loop is completed within the moving object.

6. The design method according to claim 4, wherein
the closed loop includes a loop that circulates through the moving object in the real world, an external environment in the real world, the perception system, the determination system, and the control system, and
the loop evaluates an interaction between the moving object and the external environment.

7. A non-transitory, computer readable storage medium storing a program for a driving system, which includes a plurality of subsystems and implements a dynamic driving task of a moving object in cooperation with each of the subsystems, the program, when executed by at least one processor, causing the at least one processor to:
calculate an error occurring in each of temporarily designed subsystems;
tentatively allocate, to each of the subsystems, an allowable deviation that is allowed for an entire driving system;
specify an allowable error, which is allowed for each of the subsystems, from a deviation allocated to each of the subsystems based on an evaluation on an error propagating through the driving system; and
adjust allocation of the allowable error to each of the subsystems based on a result of comparing the calculated error with an allowable error of the subsystem corresponding to the calculated error.

8. A non-transitory, computer readable storage medium storing a program for a driving system, which includes a plurality of subsystems and implements a dynamic driving task of a moving object in cooperation with each of the subsystems, the program, when executed by at least one processor, causing the at least one processor to:
introduce reliability into each of the subsystems as a common measure between each of the subsystems to evaluate a composite factor between the subsystems;
allocate the reliability to each of subsystems based on a specification of the driving system; and
determine the specification of each of the subsystems such that an error, which is generated in each of the subsystems and propagates through the driving system, falls within an allowable error with a probability of a predetermined reliability or higher.

9. A driving system which includes a plurality of subsystems and implements a dynamic driving task of a moving object in cooperation with each of the subsystems, the plurality of subsystems including a perception system, a determination system, and a control system, the driving system comprising:
at least one storage medium that is configured to store an allocation of reliability to each of the subsystems, the allocation of the reliability being a common measure between each of the subsystems and being defined for each allocation category; and
at least one processor configured to change a condition for implementing the dynamic driving task based on the allocation of the reliability.

10. The driving system according to claim 9, wherein
the storage medium includes a scenario database that constructs a catalog of a scenario, and
the at least one processor is further configured to select the scenario in which the moving object is currently placed, and
when changing the condition, the at least one processor is further configured to:
refer to the allocation of the reliability defined corresponding to the scenario; and
determine whether to transition to degeneracy action based on a product value of reliability of the perception system and reliability of the control system.
